(19) United States
(12) Patent Application Publication
(10) Pub. No.: US 2025/0322370 A1
(43) Pub. Date: Oct. 16, 2025

(54) METHODS AND SYSTEMS FOR EXPLOITING VALUE IN CERTAIN DOMAINS

(71) Applicant: Flourish Worldwide, LLC, Denver, CO (US)

(72) Inventor: Joseph J. Janiczek, Englewood, CO (US)

(73) Assignee: Flourish Worldwide, LLC, Denver, CO (US)

(21) Appl. No.: 19/248,972

(22) Filed: Jun. 25, 2025

Related U.S. Application Data
(63) Continuation-in-part of application No. 17/886,343, filed on Aug. 11, 2022, now Pat. No. 12,380,409.
Application No. 17/886,343 is a continuation of application No. 17/492,003, filed on Oct. 1, 2021, now Pat. No. 11,443,286.

(51) Int. Cl. G06Q 10/1093; G06N 20/00

(52) U.S. Cl. CPC G06Q 10/1097; G06N 20/00

(57) ABSTRACT

Aspects relate to methods and systems for exploiting value within certain domains. An exemplary method includes interrogating, using a remote device, a user for scheduling data and at least a domain, wherein the at least a domain includes at least one domain and no more than a predetermined maximum number of domains, receiving, using the remote device, the at least a domain from the user, interrogating, using the remote device, the user for domain-specific data associated with the at least a domain, receiving, using the remote device, the domain-specific data from the user, generating, using a computing device, a domain target for the at least a domain as a function of the domain-specific data, generating, using the computing device, a user schedule as a function of the domain target and the scheduling data, and displaying, using the remote device, the user schedule and the domain target to the user.

### CROSS-REFERENCE TO RELATED APPLICATIONS

This application is a continuation-in-part of U.S. Non-provisional application Ser. No. 17/886,343, filed on Aug. 11, 2022, and entitled “METHODS AND SYSTEMS FOR EXPLOITING VALUE IN CERTAIN DOMAINS,” which is a continuation of U.S. Non-provisional application Ser. No. 17/492,003 filed on Oct. 1, 2021, now U.S. Pat. No. 11,443,286, issued on Sep. 13, 2022, and entitled “METHODS AND SYSTEMS FOR EXPLOITING VALUE IN CERTAIN DOMAINS” the entirety of which is incorporated herein by reference.

### FIELD OF THE INVENTION

The present invention generally relates to the field of AI & Simulation/Modeling. In particular, the present invention is directed to methods and systems for exploiting value in certain domains.

### BACKGROUND

Many domains are present within which users are desirous of exploiting maximum value. However, user schedules are a finite-resource. A user often must handle priorities and/or conflicts with multiple life realms outside these closed or limited systems.

### SUMMARY OF THE DISCLOSURE

In some aspects, the techniques described herein relate to a method of exploiting value within a certain domain, the method including: receiving, by a computing device: scheduling data; at least a domain, wherein a quantity of domains in the at least a domain is between one and a predetermined maximum number of domains selected by a user, and domain-specific data, wherein the domain-specific data is a function of the at least a domain, generating, using a target-setting machine learning model that has been trained on target-setting training data including an exemplary plurality of domain-specific data correlated to an exemplary domain target, at least a domain target for the at least a domain as a function of the domain-specific data, generating, using a scheduling machine learning model that has been trained on scheduling training data including exemplary domain targets with exemplary user schedules, the at least a user schedule, wherein generating the at least a user schedule includes: receiving a status of at least a domain, assigning one or more state variables to the at least a domain, wherein the one or more state variables represent the status of the at least a domain, and generating the at least a user schedule as a function of the one or more state variables, and displaying, by the computing device, the at least a user schedule and the at least a domain target to the user.

In some aspects, the techniques described herein relate to a system for exploiting value within a certain domain, the system including a computing device configured to: receive at the computing device: scheduling data, at least a domain, wherein a quantity of domains in the at least a domain is between one and a predetermined maximum number of domains selected by a user, and domain-specific data, wherein the domain-specific data is a function of the at least a domain, generate, using a target-setting machine learning model that has been trained on target-setting training data including an exemplary plurality of domain-specific data correlated to an exemplary domain target, at least a domain target for the at least a domain as a function of the domain-specific data; generate, using a scheduling machine learning model that has been trained on scheduling training data including exemplary domain targets with exemplary user schedules, the at least a user schedule, wherein generating the at least a user schedule includes: receiving a status of at least a domain, assigning one or more state variables to the at least a domain, wherein the one or more state variables represent the status of the at least a domain; and generating the at least a user schedule as a function of the one or more state variables, and display, at the computing device, the at least a user schedule and the at least a domain target to the user.

These and other aspects and features of non-limiting embodiments of the present invention will become apparent to those skilled in the art upon review of the following description of specific non-limiting embodiments of the invention in conjunction with the accompanying drawings.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1 is a block diagram illustrating an exemplary system for exploiting value in certain domains;

FIG. 2 is a table illustrating exemplary domains;

FIG. 3A is an exemplary remote device including an exemplary graphical user interface;

FIG. 3B is an exemplary remote device including an exemplary graphical user interface;

FIG. 3C is an exemplary remote device including an exemplary graphical user interface;

FIG. 3D is an exemplary remote device including an exemplary graphical user interface;

FIG. 3E is an exemplary remote device including an exemplary graphical user interface;

FIG. 3F is an exemplary remote device including an exemplary graphical user interface;

FIG. 3G is an exemplary remote device including an exemplary graphical user interface;

FIG. 4 is a block diagram illustrating exemplary machine learning processes;

FIG. 5 is a block diagram illustrating an exemplary nodal network;

FIG. 6 is a block diagram illustrating an exemplary node;

FIG. 7 is a block diagram illustrating exemplary fuzzy sets;

FIG. 8 illustrates an exemplary system architecture;

FIG. 9 is a flow diagram of an exemplary method of exploiting value in certain domains; and

FIG. 10 is a block diagram of a computing system that can be used to implement any one or more of the methodologies disclosed herein and any one or more portions thereof.

The drawings are not necessarily to scale and may be illustrated by phantom lines, diagrammatic representations and fragmentary views. In certain instances, details that are not necessary for an understanding of the embodiments or that render other details difficult to perceive may have been omitted.

### DETAILED DESCRIPTION

At a high level, aspects of the present disclosure are directed to systems and methods for exploiting value in certain domains. In an embodiment, a user may select certain domains that are preferential for exploitation. The present disclosure represents a practical application of exploiting value in certain domains, in part, by allowing users to automatically have targets for domains and schedules generated. Additionally, the disclosure teaches an improvement of present computing systems as these automated tasks may be performed on a device other than the user's local device allowing access to larger computing powers and higher levels of automation.

Aspects of the present disclosure can be used to set targets to achieve with respect to certain domains. Aspects of the present disclosure can also be used to schedule plans in order to progress toward the achievement of targets. This is so, at least in part, because in some embodiments, schedules may be generated as a function of domain targets.

Aspects of the present disclosure allow for improving status within one or more domains. Exemplary embodiments illustrating aspects of the present disclosure are described below in the context of several specific examples.

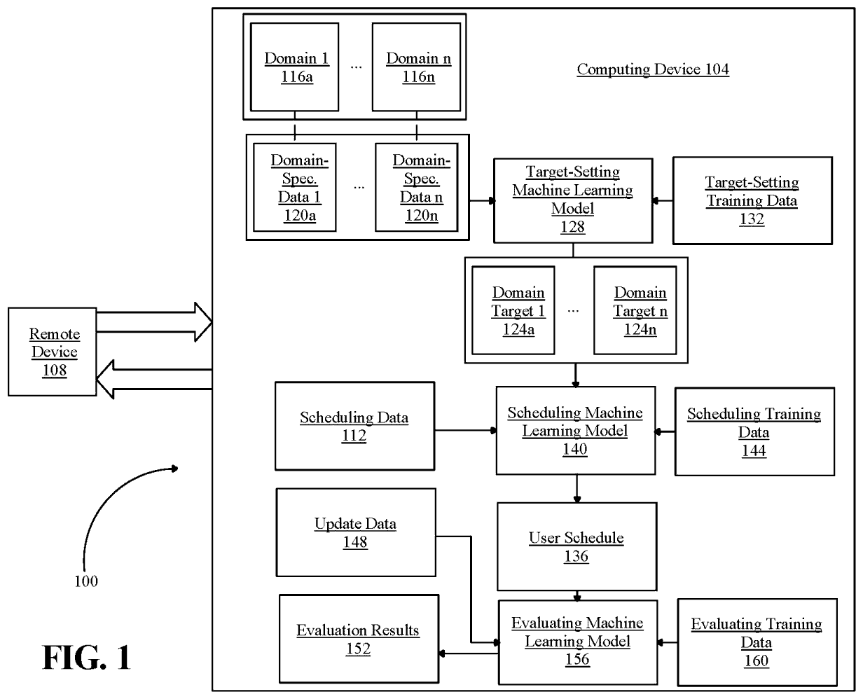

Referring now to FIG. 1, an exemplary embodiment of a system 100 for exploiting value in certain domains is illustrated. System 100 includes a computing device 104. Computing device 104 may include any computing device as described in this disclosure, including without limitation a microcontroller, microprocessor, digital signal processor (DSP) and/or system on a chip (SoC) as described in this disclosure. Computing device 104 may include, be included in, and/or communicate with a mobile device such as a mobile telephone or smartphone. Computing device 104 may include a single computing device operating independently, or may include two or more computing device operating in concert, in parallel, sequentially or the like; two or more computing devices may be included together in a single computing device or in two or more computing devices. Computing device 104 may interface or communicate with one or more additional devices as described below in further detail via a network interface device. Network interface device may be utilized for connecting computing device 104 to one or more of a variety of networks, and one or more devices. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network may employ a wired and/or a wireless mode of communication. In general, any network topology may be used. Information (e.g., data, software etc.) may be communicated to and/or from a computer and/or a computing device. Computing device 104 may include but is not limited to, for example, a computing device or cluster of computing devices in a first location and a second computing device or cluster of computing devices in a second location. Computing device 104 may include one or more computing devices dedicated to data storage, security, distribution of traffic for load balancing, and the like. Computing device 104 may distribute one or more computing tasks as described below across a plurality of computing devices of computing device, which May operate in parallel, in series, redundantly, or in any other manner used for distribution of tasks or memory between computing devices. Computing device 104 may be implemented using a “shared nothing” architecture in which data is cached at the worker, in an embodiment, this may enable scalability of system 100 and/or computing device.

With continued reference to FIG. 1, computing device 104 may be designed and/or configured to perform any method, method step, or sequence of method steps in any embodiment described in this disclosure, in any order and with any degree of repetition. For instance, computing device 104 may be configured to perform a single step or sequence repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. Computing device 104 may perform any step or sequence of steps as described in this disclosure in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

With continued reference to FIG. 1, system 100 may include a remote device 108. As used in this disclosure, a “remote device” is a computing device that is remote to another computing device. In some cases, a remote device 108 may be in communication with computing device 104 for example by way of one or more networks. One or more networks may include any network described in this disclosure. In some cases, remote device 108 may include a personal computing device, such as without limitation a smart phone, a tablet, a desktop, a laptop, or the like.

With continued reference to FIG. 1, system 100 may interrogate a user for user data. “Interrogating,” as used in this disclosure, is an act of prompting for a response. In some cases, interrogating may include displaying multiple prompts, such as without limitation fields, drop-down boxes, check boxes, radio switches, and the like. In some cases, interrogating may be performed according to a set of prompts, for instance as with a questionnaire. “User data,” as used in this disclosure, is any data that is associated with user. In some cases, user data may include scheduling data 112. As used in this disclosure, “scheduling data” is information associated with a schedule. For instance scheduling data may include days and times which a user is busy or free. In some cases, scheduling data may include calendar data, such as without limitation an Outlook calendar file, a Google calendar file, an Apple calendar file, and the like. In some cases, scheduling data may include an invite, for example an Outlook invite. In some cases, scheduling data may include temporal data (i.e., when), spatial data (i.e., where), personnel data (i.e., with whom), and the like.

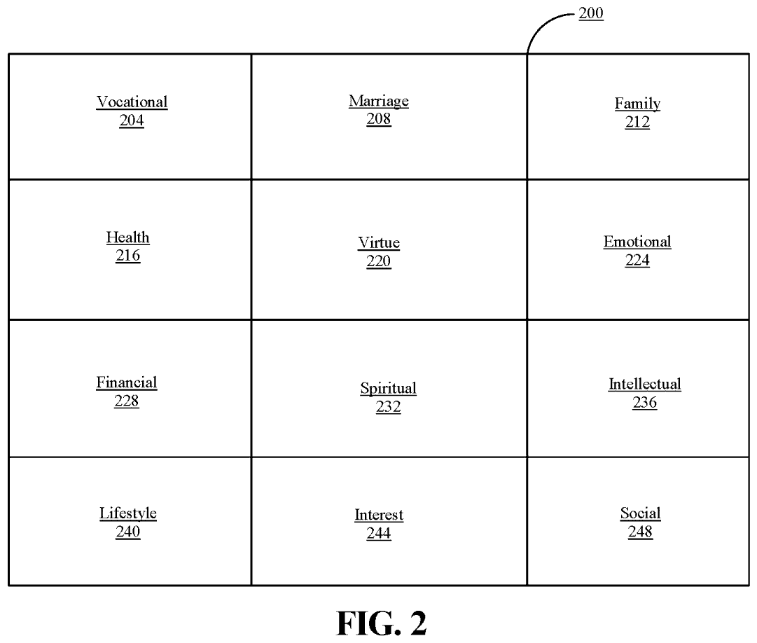

With continued reference to FIG. 1, user data may include at least a domain 116a-n. As used in this disclosure, a “domain” is an area of a user's life. Exemplary non-limiting domains include vocational domain, marriage domain, family domain, health domain, virtue domain, emotional domain, financial domain, spiritual domain, intellectual domain, lifestyle domain, interest domain, and social domain. Domain may include any domain described in this disclosure, including those described with reference to FIG. 2.

With continued reference to FIG. 1, computing device 104 may receive user data, such as one or more of scheduling data 112 and at least a domain 116a-n from user by way of remote device 108. Alternatively, or additionally, computing device 104 may receive user data from a third party on a remote device 108 and/or a local device 104. In some cases, at least a domain 116a-n may include at least one domain 116a and no more than a predetermined maximum number of domains. As used in this disclosure, a “predetermined maximum number of domains” is a high threshold which a user may select for exploitation. In some cases, predetermined maximum number of domains may be within a range of 1 and 15, for instance 10, 5, 4, 3, 2, or 1.

With continued reference to FIG. 1, system 100 may interrogate user for additional user data, including for example domain-specific data 120a-n as a function of at least a domain 116a-n. In some cases, each element of domain-specific data 120a-n may be associated with a domain of at least a domain 116a-n. As used in this disclosure, “domain-specific data” is information that is associated with a domain. Exemplary domain-specific data is described below with reference to twelve separate domains in FIG. 2. Domain-specific data may be evidential and associated with a user's current status within a domain. Alternatively or additionally, domain-specific data may be aspiration and associated with a user's desired status within a domain.

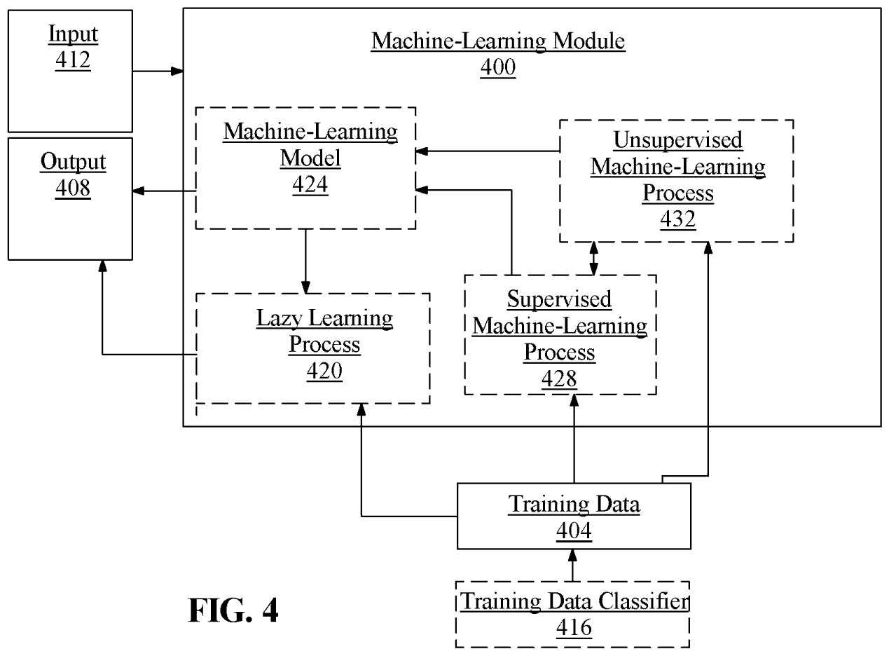

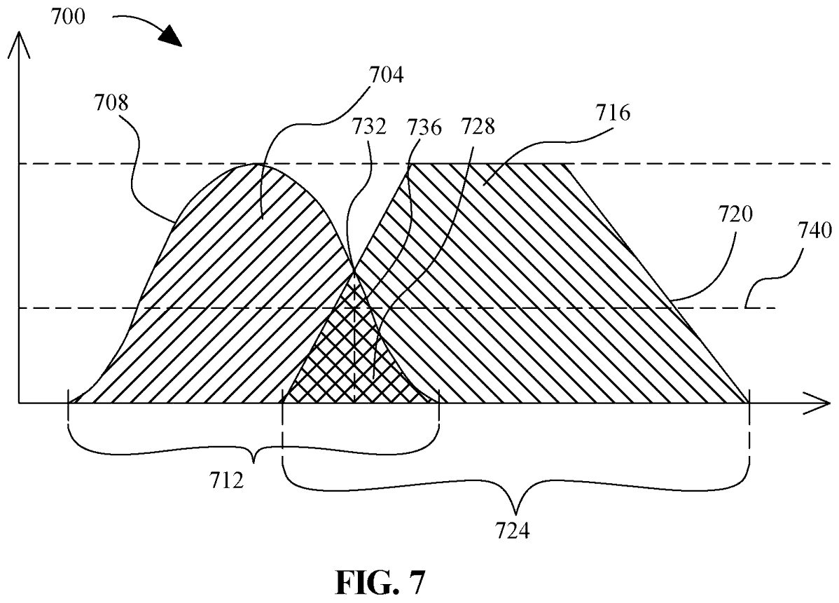

With continued reference to FIG. 1, system 100 may generate at least a domain target 124a-n for at least a domain 116a-n, for example by using computing device 104. As used in this disclosure, a “domain target” is a goal associated with a domain. In some cases, system 100 may generate at least a domain target 124a-n as a function of domain-specific data 120a-n. In some cases, each domain target of at least a domain target 124a-n may be associated with a domain of at least a domain 116a-n. In some embodiments, at least a domain target 124a-n includes a quarterly target. As used in this disclosure, a “quarterly target” is a goal that may be strived for within a quarter of a year. In some cases, a quarterly target may represent a longer-term goal or progression than can normally be achieved within a shorter schedule, such as week or a month. In some embodiments, at least a domain target 124a-n includes a yearly target. As used in this disclosure, a “yearly target” is a goal that may be strived for within a year. In some cases, a yearly target may represent a longer-term goal or progression than can normally be achieved within a shorter schedule, such as week or a month. In some embodiments, at least a domain target 124a-n includes a five-year target. As used in this disclosure, a “five-year target” is a goal that may be strived for within a five-year period. In some cases, a five-year target may represent a longer-term goal or progression than can normally be achieved within a shorter schedule, such as week or a month. In some cases, system 100 may generate at least a domain target 124a-n by using a machine learning process, for example a target-setting machine learning model 128. Target-setting machine learning model 128 may including any machine learning process described in this disclosure, including those described with reference to FIGS. 4-7. In some cases, target-setting machine learning model 128 may include a classifier, such as any classifier described in this disclosure, for example with reference to FIG. 7.

Still referring to FIG. 1, in some embodiments, target-setting machine learning model 128 may receive input including domain-specific data 120a-n. As used in this disclosure, a “target-setting machine learning model” is a machine learning process that takes as input user data, such as domain-specific data, and generates at least a domain target. Target-setting machine learning model 128 may generate at least a domain target 124a-n as a function of domain-specific data 120a-n. In some embodiments, system 100 may train target-setting machine learning model 128. In some cases, target-setting training data 132 may be input into a machine learning algorithm. Machine learning algorithm may include any machine learning algorithm described in this disclosure, including those referenced in FIGS. 4-7. As used in this disclosure, “target-setting training data” is a dataset that includes a plurality of domain-specific data correlated to a domain target. Domain-specific data and domain targets may be entered into target-setting training data manually, for example by a domain expert. In some cases, domain-specific data and domain targets may be derived for publications associated with a particular domain. Domain-specific data and domain targets may be derived from earlier instances of the system 100 or the system's operation with other users or with a same user associated with a different domain. System 100 may train target-setting machine learning model 128 as a function of machine-learning algorithm and/or target-setting training data 132.

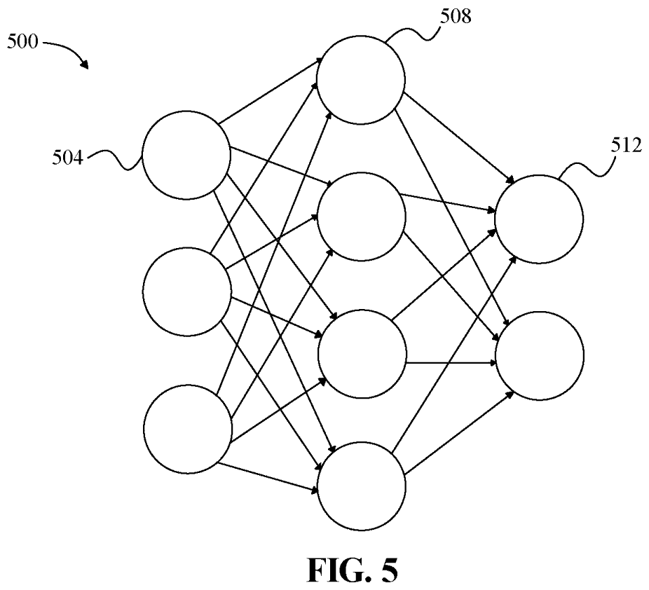

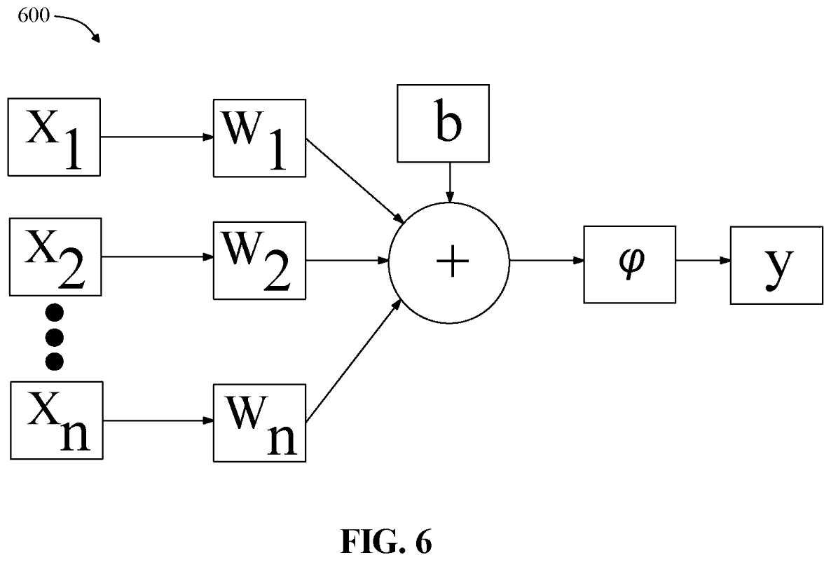

With continued reference to FIG. 1, system 100 may generate a user schedule 136, for example by using computing device 104. As used in this disclosure, a “user schedule” is a list of planned events with corresponding dates and times for a user. In some cases, system 100 may generate user schedule 136 as a function of one or more of at least a domain target 124a-n and scheduling data 112. In some embodiments, at least a user schedule 136 may include a daily schedule. In some cases, a daily schedule may include events or activities which are intended to help a user progress (and ultimately flourish) within at least a domain 116a-n. As used in this disclosure, a “daily schedule” is a schedule that spans a day, i.e., 24 hours. In some embodiments, at least a user schedule 136 may include a weekly schedule. As used in this disclosure, a “weekly schedule” is a schedule that spans a week, i.e., seven days. In some embodiments, at least a user schedule 136 may include a monthly schedule. As used in this disclosure, a “monthly schedule” is a schedule that spans a month, i.e., 29, 28, 30, or 31 days. In some cases, a monthly schedule may include events or activities which are intended to help a user progress (and ultimately flourish) within at least a domain 116a-n. In some cases, system 100 may generate user schedule 136 by using a machine learning process, for example a scheduling machine learning model 140. Scheduling machine learning model 140 may including any machine learning process described in this disclosure, including those described with reference to FIGS. 4-7. In some cases, scheduling machine learning model 140 may include a neural network, such as neural networks described in this disclosure, for example with reference to FIGS. 5-6. Still referring to FIG. 1, in some embodiments, scheduling machine learning model 140 may receive input including one or more of at least a domain target 124a-n and scheduling data 112. As used in this disclosure, a “scheduling machine learning model” is a machine-learning process that that takes as input one or more of at least a domain target and user data, such as scheduling data, and generates at least a domain target. System 100 may generate at least a user schedule 136 as a function of scheduling machine learning model 140. In some embodiments, system 100 may train scheduling machine learning model 140. In some cases, training scheduling machine learning model 140 may include inputting scheduling training data 144 to a machine learning algorithm. As used in this disclosure, “scheduling training data” is a dataset that includes a plurality of domain targets correlated to schedule components. Domain targets and schedule components may be entered into scheduling training data manually, for example by a domain expert. In some cases, domain targets and scheduling components may be derived for publications associated with a particular domain. Domain targets and scheduling components may be derived from earlier instances of the system 100 or the system's operation with other users or with a same user associated with a different domain. Machine learning algorithm may include any machine learning algorithm described in this disclosure, for example those described with reference to FIGS. 4-7. As used in this disclosure, a “schedule component” is information that includes event data and temporal data. A schedule component may be included in a schedule. A schedule component may include a location. An exemplary schedule component is “kettle-bell workout, duration of 30 min, located at gym.” System 100 may train scheduling machine learning model 140 as a function of machine-learning algorithm. In some cases, scheduling machine learning model 140 may be a function of one or more automated planning and scheduling algorithms. Additionally disclosure related to automated planning and scheduling algorithms may be found with reference to FIG. 4.

With continued reference to FIG. 1, in some embodiments, generating or modifying user schedule 136 may further include incorporating a motivational modifier based on an inferred courage type. For example, system 100 may receive an output from the courage typing layer or the courage classification model, and may modify one or more of the scheduled components, timing, or prioritization of activities as a function of the inferred courage type. In an embodiment, the scheduling machine learning model 140 may adapt its scheduling decisions to include courage-aligned actions, such as ideation-focused sessions during a “Be Creative” phase or accountability tasks during an “Achieve Consistency” phase. Accordingly, user schedule 136 may be personalized to reflect not only domain-specific targets, but also the user's motivational state. Motivational modifiers and inferred courage types are discussed in further detail below.

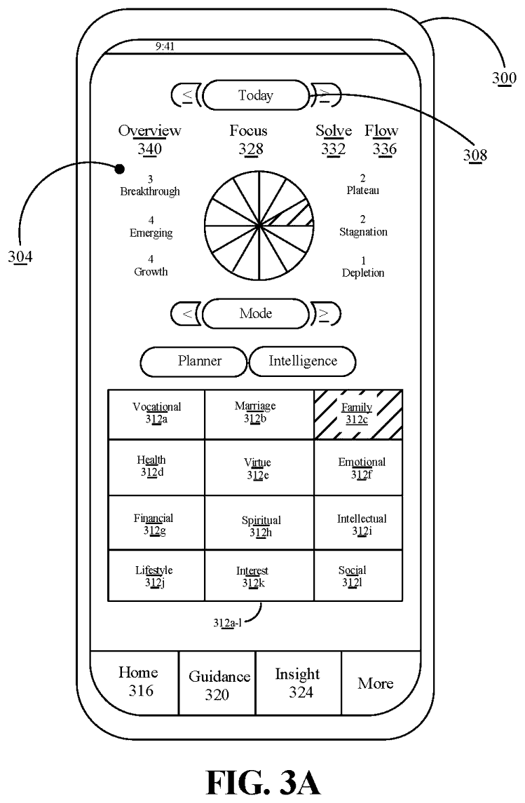

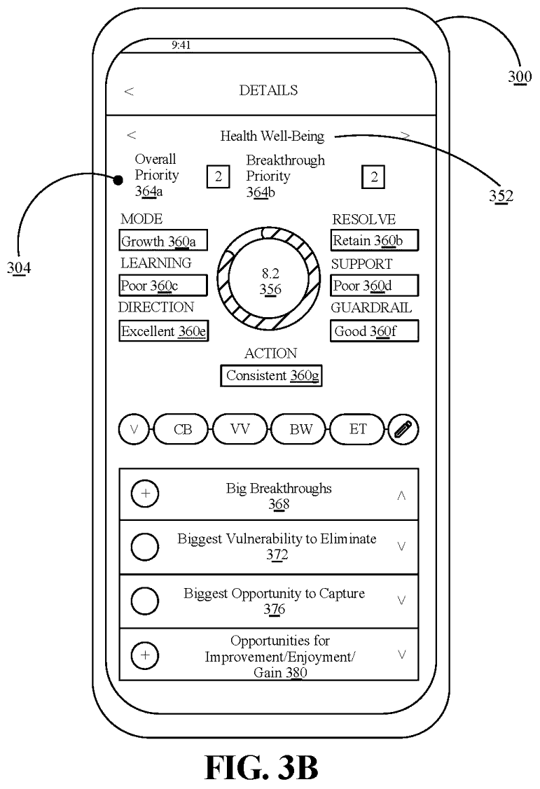

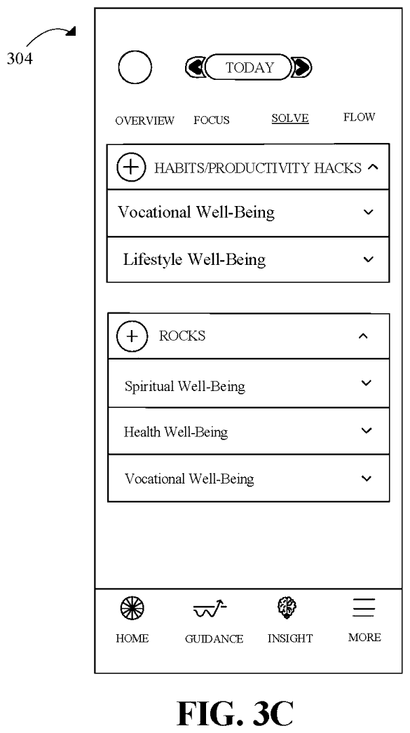

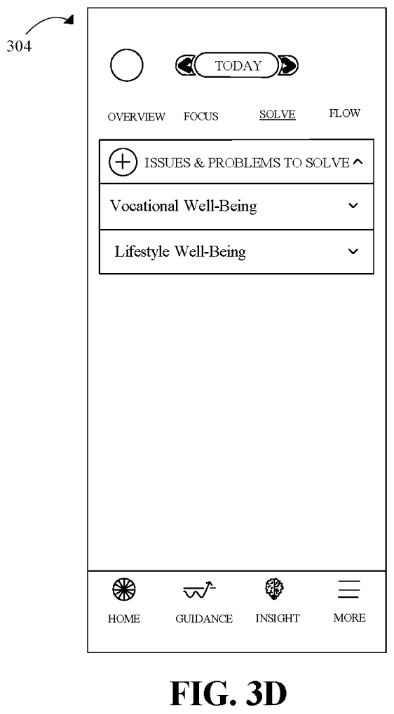

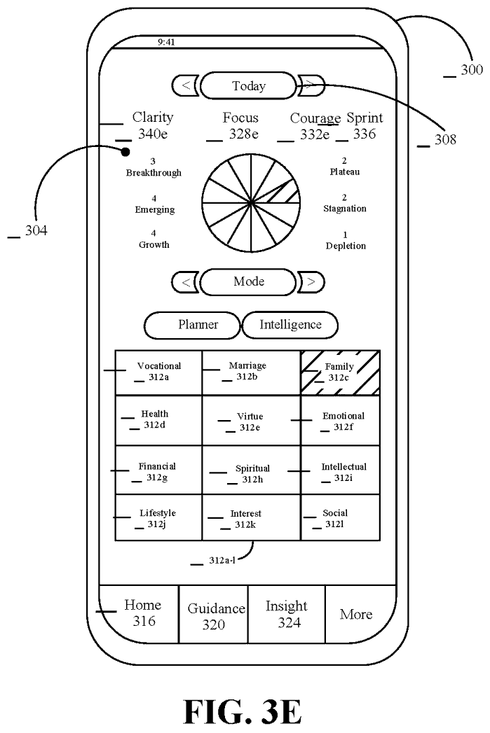

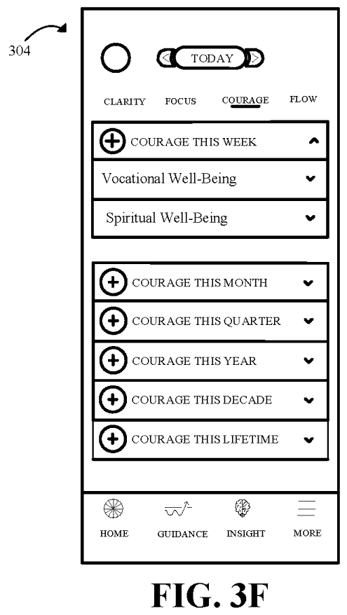

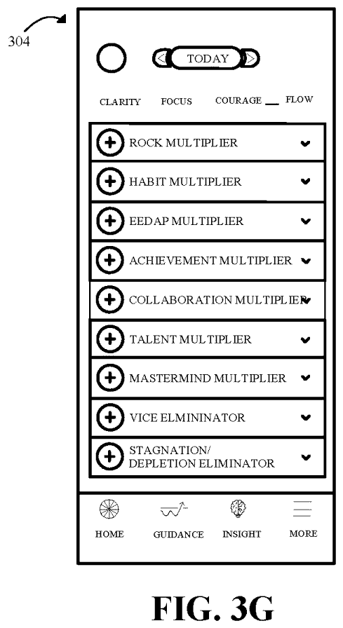

With continued reference to FIG. 1, system 100 may display one or more of at least a user schedule 136 and at least a domain target 124a-n user, for example by way of remote device 108. In some cases, remote device 108 may display to user by way of a graphical user interface (GUI). GUI may be presented to user as part of an application operating upon remote device. GUI may include text and graphics intended to communicate information as well as prompts and interfaces with which as user may input information. An exemplary GUI is illustrated in FIG. 3A and/or 3B.

Still referring to FIG. 1, in some embodiments, system 100 may interrogate user for update data 148, for example by using remote device. As used in this disclosure, “update data” is information derived or received from user after generation of one or more of at least a user schedule and at least a domain target. In some cases, update data may be useful in determining a user's adherence to a user schedule or progress toward a domain target. In some cases, system 100 may receive update data 148 automatically, for example without knowledge of user. For example, in some cases, update data 148 may be ascertained from data detectable by remote device, e.g., location data, screen time, application time, and the like. In some cases, update data 148 may include objective update data 148. As used in this disclosure, “objective update data” is update data that is objective in quality, for example amount of time a user spent undertaking an event on user schedule. In some cases, update data 148 may include subjective update data 148. As used in this disclosure, “subjective update data” is update data that is subjective in quality, for example how a user rates changes to her social life may be subjective update data relating to a social domain.

Still referring to FIG. 1, in some embodiments, system 100 may evaluate update data 148 as a function user schedule 136 and/or domain target 124a-n, for example using computing device 104. Evaluating update data 148 may yield evaluation results 152. As used in this disclosure, “evaluation results” are information originating from evaluation of update data. In some cases, system 100 may display evaluation results 152 to user, for example by way of remote device 108 and/or a graphical user interface.

Still referring to FIG. 1, in some embodiments, system 100 may evaluate update data 148 using an evaluating machine learning model 156. As used in this disclosure, an “evaluating machine learning model” is a machine learning process that takes update data as input and generate evaluation results. Computing device 104 may input one or more of update data 148 and at least a user schedule 136 to an evaluating machine learning model 156. Computing device 104 may generate evaluation results 152 as a function of evaluating machine learning model 156. In some embodiments, system 100 may train evaluating machine learning model 156 using evaluating training data 160. As used in this disclosure, “evaluating training data” is a dataset that includes a plurality of update data correlated to evaluations. Update data and evaluations may be entered into evaluation training data manually, for example by an evaluation expert. In some cases, update data and evaluations may be derived for publications associated with a particular domain. Update data and evaluations may be derived from earlier instances of the system 100 or the system's operation with other users or with a same user associated with a different domain. In some cases, evaluating training data may include a plurality of update data and at least a domain correlated to evaluations. In some cases, an evaluation may be representative of an association between a domain status and a domain target. Computing device 104 may input evaluating training data 160 to a machine learning algorithm. Machine learning algorithm may include any machine learning algorithm, for example those disclosed with reference to FIGS. 4-7. Computing device 104 may train evaluating machine learning model 156 as a function of machine-learning algorithm.

Still referring to FIG. 1, in some embodiments, system 100 may notify user. For instance, system 100 may notify user as a function of evaluation results 152. In some cases, system 100 may notify user using remote device 108. System 100 may notify user by way of an application and/or a graphical user interface running on remote device. Alternatively or additionally, in some cases, remote device 108 may include text messaging capabilities and system 100 may notify user by way of a text message. As used in this disclosure, a “text message” is message communicated by way of one or more of short message service (SMS) and multimedia messaging service (MMS). Still referring to FIG. 1, in some embodiments, system 100 may allow a user to modify a schedule. For example, in some cases, a use schedule 136, which may be autogenerated, is not practical or otherwise acceptable to a user. In this case, a user may submit a schedule change request, for example from remote device 108. As used in this disclosure, a “schedule change request” is information that includes a modification to a user schedule. Computing device 104 may receive at least a schedule change request from user. Computing device 104 may modify at least a user schedule as a function of schedule change request. Exemplary, schedule change requests may include commands to change a time of a schedule component, change a location of a schedule component, change an invite list of a schedule component, change an event/activity of a schedule component, delete a schedule component, and add a schedule component. In some cases, a schedule change request may include a request to change a prioritization or inclusion of at least a domain 116a-n. In some cases, a schedule change request may cause a regeneration of user schedule 136, for example by using one or more machine learning processes (e.g., scheduling machine learning model 140). In some embodiments, notifying a user may include a notification on remote device. As used in this disclosure, a “notification” is an interrupting alarm, for example facilitated by background operation of a graphical user interface. In some cases, a notification may be first authorized by user, for example through use of remote device ‘settings.’ In some cases, notifications may be disabled to avoid disruption and/or interruption. As used in this disclosure, an “authorized notification” is a notification which has been authorized.

Still referring to FIG. 1, in some cases, system 100 may include a machine learning process configured to identify effective ways to motivate user. In some cases, machine learning process may include a trained machine learning model. In some cases, machine learning model may be trained using training data correlating previous outputs (e.g., user schedule, domain targets, and the like) to subsequent updates for users generally. Alternatively, or additionally, in some cases, machine learning model may be trained using training data correlating previous outputs to updates for an individual user or a class (i.e., cohort) of similar users. In some cases, a cohort of users may be determined by a classifier. Classifier may include any classifier described in this disclosure, for example a clustering algorithm (e.g., K-means clustering algorithm, particle swarm optimization, and the like).

With further reference to FIG. 1, in a non-limiting embodiment, the machine learning process configured to identify effective ways to motivate a user may include one or more personalized inference layers trained to associate behavioral, contextual, spiritual, and psychological data with motivational response types. In some embodiments, the machine learning process may include a courage typing layer. For purposes of this disclosure, a “courage typing layer” is a subcomponent configured to identify the most relevant form of motivational courage from a defined set of archetypal courage forms. In this embodiment, the courage typing layer may operate as a distinct layer within a broader motivation-identification model, such as the model described above, and may provide auxiliary features to one or more downstream machine learning models, including the scheduling machine learning model 140 and evaluating machine learning model 156. In some cases, the courage typing layer may output a motivational modifier (e.g., courage vector or label) that influences how schedule components are selected, how evaluation results are interpreted, or how motivational feedback is delivered to a user. In a non-limiting embodiment, the courage typing layer may be configured to identify one or more of eight unique courage types arranged in a progressive order. For purposes of this disclosure, “progressive order” is a sequential arrangement in which components, phases, or actions proceed according to a defined hierarchy, developmental trajectory, or escalating level of complexity, priority, or commitment. A progressive order may reflect a temporal sequence, a learning or maturation path, a priority structure, or a model of transformation or improvement across defined stages. The courage types may include, without limitation: (1) Engage Faith, the courage to envision a future unconstrained by present limitations using imagination, hope, faith, spiritual belief, or transcendence; (2) Gain Clarity, the courage to deeply investigate what is involved in pursuing that vision, including existing conditions, obstacles, costs, and resource needs and how such aligns with one's stated overall life purpose or aim, priorities, values, and stated spiritual and transcendental beliefs; (3) Make Commitment, the courage to decisively pursue the vision despite uncertainty and the need for personal sacrifice and personal reliance on one's faith and/or spiritual beliefs as such a leap into the unknown is made; (4) Be Creative, the courage to iterate through failure, experimentation, and learning to overcome obstacles, solve problems, pinpoint and address issues, and ultimately find one's way to a viable solution that promises to achieve or exceed one's stated vision; (5) Develop Capability, the courage to refine early creative outputs into scalable and repeatable methods, capabilities and systems; (6) Achieve Consistency, the courage to operationalize and apply those systems across varying conditions with highly predictable results; (7) Authentically Rest, the courage to let the solution or system prove itself without over management; and (8) Proactively Repeat, the courage to reinitiate the entire cycle at a higher level of refinement prior to a critical need for such innovation. In some cases, the courage typing layer may additionally account for transitional motivational states such as vice, defined as a thought, mindset, or activity that is standing in the way of achieving desired results and trigger recommendations, suggestions, questions, and actions to pinpoint and eliminate such a vice. Similarly, in some cases the courage typing layer may detect signs of stagnation or depletion in the pursuit of such a vision and trigger recommendations, suggestions, questions, and actions to pinpoint and eliminate such stagnation or depletion.

With further reference to FIG. 1, as used in this disclosure, a “transitional motivational state” is a psychological condition that arises as a user moves between defined courage types within the motivational progression. Transitional motivational states may include, without limitation, states of ambivalence, hesitancy, partial readiness, incongruity with faith and spiritual beliefs and inputs, or motivational ambiguity that are not yet fully aligned with a particular courage phase. In some embodiments, system 100 may identify transitional motivational states by detecting mixed behavioral signals, inconsistent user feedback, or conflicting semantic indicators in journaling entries or update data 148. For example, if a user expresses enthusiasm about a vision (suggesting “Engage Faith”) but concurrently expresses confusion or overwhelm about next steps (suggesting “Gain Clarity”), system 100 may classify this as a transitional motivational state and delay full-phase reassignment until additional disambiguating input is received. Transitional motivational states may be used to generate intermediate coaching prompts, defer goal advancement, or activate diagnostic routines aimed at clarifying the user's intent, emotional posture, or contextual constraints.

With further reference to FIG. 1, in response to identifying such a transitional motivational state, system 100 may trigger a targeted eliminator intervention as a function of the specific transitional state. As used in this disclosure, an “eliminator intervention” is a system-initiated corrective action designed to help a user resolve ambiguity, blockage, or motivational conflict that prevents progression to a clearly defined courage type. Eliminator interventions may operate to “clear out” indecisiveness, misalignment, incompatibility, or depletion and to reorient the user toward constructive momentum. Triggering an eliminator intervention may include detecting, by computing device 104, that user input data, such as update data 148, journaling responses, behavior logs, or evaluation results 152, exhibit patterns characteristic of a transitional motivational state. Once identified, system 100 may use a rules-based mapping, classifier, or reinforcement learning model to select an appropriate eliminator intervention aligned with the detected transition blockage. In some embodiments, the selected eliminator intervention is a function of the specific transitional motivational state, meaning the intervention is chosen based on which courage types are being bridged, the nature of the blockage, and user-specific context. Eliminator interventions may include, without limitation, vice eliminators, stagnation eliminators, depletion eliminators, ambiguity eliminators, misclassification eliminators, and inconsistency eliminators. Vice eliminators may surface hidden avoidance patterns, limiting beliefs, or misaligned coping strategies that interfere with progress, such as excessive distraction or self-sabotage. Stagnation eliminators may prompt the user to confront circular reasoning, disengagement, or repetition without growth through diagnostic journaling or recommitment challenges. Depletion eliminators may assess emotional or cognitive fatigue and recommend restorative actions such as reflection, rest, or simplification of commitments. Ambiguity eliminators may help clarify values, intentions, or competing goals through guided exercises or disambiguation prompts. Misclassification eliminators may confirm or refute the current courage-type classification by prompting user reflection on recently completed actions or unmet needs. Inconsistency eliminators may highlight disconnects between stated values and actions, often using side-by-side data displays or LLM-generated feedback. In some embodiments, additional personalized interventions may be dynamically generated by the LLM-based content engine as described herein.

In an exemplary use case, if a user exhibits language suggesting inspiration but consistently fails to commit to next steps, system 100 may identify a transitional motivational state between “Engage Faith” and “Make Commitment” and trigger a vice eliminator focused on uncovering avoidance mechanisms. Alternatively, if a user repeatedly revisits ideation but lacks forward movement, a stagnation eliminator may guide them toward goal prioritization or task scoping for transition to “Develop Capability.” This adaptive eliminator framework allows system 100 to maintain user alignment with the intended motivational progression, reduce friction during psychological transition phases, and support ongoing domain flourishing through precision-targeted interventions.

In continued reference to FIG. 1, in another embodiment, the courage typing functionality may be implemented as a standalone machine learning model, referred to herein as a courage classification model, that is configured to receive user data, including but not limited to domain-specific data 120a-n, update data 148, subjective motivational feedback, and domain targets 124a-n, and to output an inferred courage type from the defined set of eight. The courage classification model may be trained using a dataset that correlates historical user inputs, behavioral patterns, and motivational outcomes with effective courage strategies. In some embodiments, the courage classification model may generate a confidence score or probability distribution over possible courage types, which may then be used to trigger an automated motivational intervention or recommendation. In some cases, the model may detect motivational stagnation, avoidance behavior, or regression, and trigger presentation of eliminator prompts or resources aligned with vice or depletion elimination. While the courage typing layer may operate as an embedded component supplying context to other models, the standalone courage classification model may operate asynchronously or on demand to periodically reassess and reclassify motivational state.

Still referring to FIG. 1, in some embodiments, each of the eight courage types may be determined by the courage typing layer or courage classification model based on a multi-dimensional analysis of user data. Inputs may include one or more of: (i) domain-specific data 120a-n such as stated goals, self-assessment responses, or behavior patterns within a specific domain; (ii) update data 148, including activity adherence, emotional sentiment derived from journaling or prompts, physiological data, or usage patterns; (iii) evaluation results 152, including measured or inferred progress toward domain targets 124a-n; (iv) contextual metadata, such as deadline proximity, historical courage transitions, or domain volatility; and (v) explicit user input, such as journaling content, question responses, or interaction with coaching modules. In some cases, the system may use natural language processing (NLP) to extract semantic indicators from textual inputs, such as expression of uncertainty (suggesting need for Gain Clarity), forward-leaning aspiration (suggesting Engage Faith), or repeated stalled progress (suggesting need for Make Commitment or Vice Eliminator activation).

With further reference to FIG. 1, extracting semantic indicators from textual inputs may include using a language processing module. Language processing module may include any hardware and/or software module. Language processing module may be configured to extract, from one or more documents and/or other textual inputs, one or more words. One or more words may include, without limitation, strings of one or more characters, including without limitation any sequence or sequences of letters, numbers, punctuation, diacritic marks, engineering symbols, geometric dimensioning and tolerancing (GD&T) symbols, chemical symbols and formulas, spaces, whitespace, and other symbols, including any symbols usable as textual data as described above. Textual data may be parsed into tokens, which may include a simple word (sequence of letters separated by whitespace) or more generally a sequence of characters as described previously. The term “token,” as used herein, refers to any smaller, individual groupings of text from a larger source of text; tokens may be broken up by word, pair of words, sentence, or other delimitation. These tokens may in turn be parsed in various ways. Textual data may be parsed into words or sequences of words, which may be considered words as well. Textual data may be parsed into “n-grams”, where all sequences of n consecutive characters are considered. Any or all possible sequences of tokens or words may be stored as “chains”, for example for use as a Markov chain or Hidden Markov Model.

Still referring to FIG. 1, language processing module may operate to produce a language processing model. Language processing model may include a program automatically generated by computing device and/or language processing module to produce associations between one or more words extracted from at least a document and detect associations, including without limitation mathematical associations, between such words. Associations between language elements, where language elements include for purposes herein extracted words, relationships of such categories to other such term may include, without limitation, mathematical associations, including without limitation statistical correlations between any language element and any other language element and/or language elements. Statistical correlations and/or mathematical associations may include probabilistic formulas or relationships indicating, for instance, a likelihood that a given extracted word indicates a given category of semantic meaning. As a further example, statistical correlations and/or mathematical associations may include probabilistic formulas or relationships indicating a positive and/or negative association between at least an extracted word and/or a given semantic meaning; positive or negative indication may include an indication that a given document is or is not indicating a category semantic meaning. Whether a phrase, sentence, word, or other textual element in a document or corpus of documents constitutes a positive or negative indicator may be determined, in an embodiment, by mathematical associations between detected words, comparisons to phrases and/or words indicating positive and/or negative indicators that are stored in memory at computing device, or the like.

Still referring to FIG. 1, in an embodiment, language processing module and/or diagnostic engine may generate the language processing model by any suitable method, including without limitation a natural language processing classification algorithm; language processing model may include a natural language process classification model that enumerates and/or derives statistical relationships between input terms and output terms. Algorithm to generate language processing model may include a stochastic gradient descent algorithm, which may include a method that iteratively optimizes an objective function, such as an objective function representing a statistical estimation of relationships between terms, including relationships between input terms and output terms, in the form of a sum of relationships to be estimated. In an alternative or additional approach, sequential tokens may be modeled as chains, serving as the observations in a Hidden Markov Model (HMM). HMMs as used herein are statistical models with inference algorithms that that may be applied to the models. In such models, a hidden state to be estimated may include an association between an extracted words, phrases, and/or other semantic units. There may be a finite number of categories to which an extracted word may pertain; an HMM inference algorithm, such as the forward-backward algorithm or the Viterbi algorithm, may be used to estimate the most likely discrete state given a word or sequence of words. Language processing module may combine two or more approaches. For instance, and without limitation, machine-learning program may use a combination of Naive-Bayes (NB), Stochastic Gradient Descent (SGD), and parameter grid-searching classification techniques; the result may include a classification algorithm that returns ranked associations.

Alternatively, or additionally, and with continued reference to FIG. 1, language processing module may be produced using one or more large language models (LLMs). A “large language model,” as used herein, is a deep learning data structure that can recognize, summarize, translate, predict and/or generate text and other content based on knowledge gained from massive datasets. Large language models may be trained on large sets of data. In the context of the present invention, LLMs may be employed to classify user-submitted textual inputs, such as journaling entries, coaching prompt responses, and motivational reflections, into one or more predefined courage types, or to generate dynamic language outputs aligned with the user's current motivational state. In some embodiments, LLMs may be fine-tuned on domain-specific datasets reflecting successful user transitions through the eight courage phases (e.g., Engage Faith, Gain Clarity, Make Commitment, etc.), as well as examples of motivational stagnation, resistance, or depletion. Training sets may include anonymized user communications, structured coaching dialogue transcripts, tagged milestone achievement narratives, and curated best-practice content across vocational, wellness, relationship, and personal development domains. These models may be used to extract semantic intent, identify courage-aligned sentiment, suggest next-step actions, or verify readiness for transition to a new courage phase. In further embodiments, outputs of the LLM may be used to populate scheduling or evaluation subsystems, or to tailor interactive user dialogue for maximum motivational impact. In some embodiments, training sets of an LLM may include information from one or more public or private databases. As a non-limiting example, training sets may include databases associated with an entity. In some embodiments, training sets may include portions of documents associated with the electronic records correlated to examples of outputs. In an embodiment, an LLM may include one or more architectures based on capability requirements of an LLM. Exemplary architectures may include, without limitation, GPT (Generative Pretrained Transformer), BERT (Bidirectional Encoder Representations from Transformers), T5 (Text-To-Text Transfer Transformer), and the like. Architecture choice may depend on a needed capability such generative, contextual, or other specific capabilities.

With continued reference to FIG. 1, in some embodiments, an LLM may be generally trained. As used in this disclosure, a “generally trained” LLM is an LLM that is trained on a general training set comprising a variety of subject matters, data sets, and fields. In some embodiments, an LLM may be initially generally trained. Additionally, or alternatively, an LLM may be specifically trained. As used in this disclosure, a “specifically trained” LLM is an LLM that is trained on a specific training set, wherein the specific training set includes data including specific correlations for the LLM to learn. As a non-limiting example, an LLM may be generally trained on a general training set, then specifically trained on a specific training set. In an embodiment, specific training of an LLM may be performed using a supervised machine learning process. In some embodiments, generally training an LLM may be performed using an unsupervised machine learning process. As a non-limiting example, specific training set may include information from a database. As a non-limiting example, specific training set may include text related to the users such as user specific data for electronic records correlated to examples of outputs. In an embodiment, training one or more machine learning models may include setting the parameters of the one or more models (weights and biases) either randomly or using a pretrained model. Generally training one or more machine learning models on a large corpus of text data can provide a starting point for fine-tuning on a specific task. A model such as an LLM may learn by adjusting its parameters during the training process to minimize a defined loss function, which measures the difference between predicted outputs and ground truth. Once a model has been generally trained, the model may then be specifically trained to fine-tune the pretrained model on task-specific data to adapt it to the target task. Fine-tuning may involve training a model with task-specific training data, adjusting the model's weights to optimize performance for the particular task. In some cases, this may include optimizing the model's performance by fine-tuning hyperparameters such as learning rate, batch size, and regularization. Hyperparameter tuning may help in achieving the best performance and convergence during training. In an embodiment, fine-tuning a pretrained model such as an LLM may include fine-tuning the pretrained model using Low-Rank Adaptation (LoRA). As used in this disclosure, “Low-Rank Adaptation” is a training technique for large language models that modifies a subset of parameters in the model. Low-Rank Adaptation may be configured to make the training process more computationally efficient by avoiding a need to train an entire model from scratch. In an exemplary embodiment, a subset of parameters that are updated may include parameters that are associated with a specific task or domain.

With the foundational training and fine-tuning procedures described above, the present system may leverage both classical NLP techniques and advanced transformer-based large language models to interpret and respond to user inputs. These models may operate to classify motivational state, extract intent and sentiment, generate context-aware prompts, and dynamically tailor interventions aligned with a user's evolving courage type. By combining tokenization, statistical language modeling, semantic vector space representation, and transformer architectures, system 100 can detect subtle motivational cues, track phase-specific transitions, and provide guidance that aligns with validated psychological frameworks. In particular, attention-based mechanisms within LLMs allow the system to focus on the most relevant segments of a user's language, ensuring that generated outputs, such as coaching messages, scheduling prompts, or courage-type classifications, are contextually appropriate and motivationally impactful. The following sections describe in greater detail how these transformer components, including self-attention and multi-headed attention mechanisms, function within the system to support such capabilities.

With continued reference to FIG. 1, in some embodiments an LLM may include and/or be produced using Generative Pretrained Transformer (GPT), such as GPT-2, GPT-3, GPT-3.5, GPT-4, or similar architectures. GPT, GPT-2, GPT-3, GPT-3.5, and GPT-4 are products of OpenAI Inc., of San Francisco, CA. An LLM may include a text prediction or generation algorithm configured to analyze user-generated language (e.g., journal entries, reflection prompts, coaching dialogue) and predict semantically aligned next responses or classifications based on the motivational context. For example, if a user writes “I've been thinking about starting a new career but I'm not sure where to begin,” the LLM may assign high likelihood to courage types such as “Engage Faith” or “Gain Clarity” and may generate follow-up prompts such as “What's the future vision you're imagining?” or “What would success look like to you in that role?” In some cases, the LLM may rank multiple candidate outputs by relevance, enabling the system to choose the best-fit follow-up or recommendation. In further embodiments, the LLM may output a courage classification vector or a probability distribution across the eight courage types, which may be passed to downstream systems for adaptive scheduling, feedback generation, or content curation. The LLM may include encoder and decoder components for transforming free-text inputs into latent semantic features and for generating human-aligned coaching dialogue consistent with best practices associated with each courage phase.

Still referring to FIG. 1, an LLM may include a transformer architecture. In some embodiments, encoder component of an LLM may include transformer architecture. A “transformer architecture,” for the purposes of this disclosure is a neural network architecture that uses self-attention and positional encoding. Transformer architecture may be designed to process sequential input data, such as natural language, with applications towards tasks such as translation and text summarization. Transformer architecture may process the entire input all at once. “Positional encoding,” for the purposes of this disclosure, refers to a data processing technique that encodes the location or position of an entity in a sequence. In some embodiments, each position in the sequence may be assigned a unique representation. In some embodiments, positional encoding may include mapping each position in the sequence to a position vector. In some embodiments, trigonometric functions, such as sine and cosine, may be used to determine the values in the position vector. In some embodiments, position vectors for a plurality of positions in a sequence may be assembled into a position matrix, wherein each row of position matrix may represent a position in the sequence.

With continued reference to FIG. 1, an LLM and/or transformer architecture may include an attention mechanism. An “attention mechanism,” as used herein, is a part of a neural architecture that enables a system to dynamically quantify the relevant features of the input data. In the case of natural language processing, input data may be a sequence of textual elements. It may be applied directly to the raw input or to its higher-level representation.

With continued reference to FIG. 1, attention mechanism may represent an improvement over a limitation of an encoder-decoder model. An encoder-decider model encodes an input sequence to one fixed length vector from which the output is decoded at each time step. This issue may be seen as a problem when decoding long sequences because it may make it difficult for the neural network to cope with long sentences, such as those that are longer than the sentences in the training corpus. Applying an attention mechanism, an LLM may predict the next word by searching for a set of positions in a source sentence where the most relevant information is concentrated. An LLM may then predict the next word based on context vectors associated with these source positions and all the previously generated target words, such as textual data of a dictionary correlated to a prompt in a training data set. A “context vector,” as used herein, are fixed-length vector representations useful for document retrieval and word sense disambiguation.

Still referring to FIG. 1, attention mechanism may include, without limitation, generalized attention self-attention, multi-head attention, additive attention, global attention, and the like. In generalized attention, when a sequence of words or an image is fed to an LLM, it may verify each element of the input sequence and compare it against the output sequence. Each iteration may involve the mechanism's encoder capturing the input sequence and comparing it with each element of the decoder's sequence. From the comparison scores, the mechanism may then select the words or parts of the image that it needs to pay attention to. In self-attention, an LLM may pick up particular parts at different positions in the input sequence and over time compute an initial composition of the output sequence. In multi-head attention, an LLM may include a transformer model of an attention mechanism. Attention mechanisms, as described above, may provide context for any position in the input sequence. For example, if the input data is a natural language sentence, the transformer does not have to process one word at a time. In multi-head attention, computations by an LLM may be repeated over several iterations, each computation may form parallel layers known as attention heads. Each separate head may independently pass the input sequence and corresponding output sequence element through a separate head. A final attention score may be produced by combining attention scores at each head so that every nuance of the input sequence is taken into consideration. In additive attention (Bahdanau attention mechanism), an LLM may make use of attention alignment scores based on a number of factors. Alignment scores may be calculated at different points in a neural network, and/or at different stages represented by discrete neural networks. Source or input sequence words are correlated with target or output sequence words but not to an exact degree. This correlation may take into account all hidden states and the final alignment score is the summation of the matrix of alignment scores. In global attention (Luong mechanism), in situations where neural machine translations are required, an LLM may either attend to all source words or predict the target sentence, thereby attending to a smaller subset of words.

With continued reference to FIG. 1, multi-headed attention within the encoder of an LLM may apply a specific attention mechanism known as self-attention. Self-attention enables the model to analyze relationships between all parts of a user input sequence, allowing it to assign relative importance to each word or phrase in context. In the present invention, self-attention mechanisms may allow the LLM to identify motivational cues, hesitations, or affirmations within free-form user reflections and prompt responses. For example, if a user enters the sentence, “I keep trying, but I feel stuck and unsure if this is worth it,” the model may learn to associate emotionally weighted terms like “stuck” and “unsure” with diagnostic indicators relevant to the “Make Commitment” or “Vice Eliminator” courage types. Similarly, phrases like “I keep trying” may be weighted more heavily in the “Be Creative” or “Develop Capability” stages. The self-attention mechanism allows the LLM to consider not just individual keywords, but the broader semantic structure of user inputs to infer intent, emotional tone, and contextual readiness. In this way, the courage typing and dialog generation functionality of the system can more accurately tailor motivational interventions and progress recommendations. In some embodiments, to achieve self-attention, input may be fed into three distinct fully connected neural network layers to create query, key, and value vectors. A query vector may include an entity's learned representation for comparison to determine attention score. A key vector may include an entity's learned representation for determining the entity's relevance and attention weight. A value vector may include data used to generate output representations. Query, key, and value vectors may be fed through a linear layer; then, the query and key vectors may be multiplied using dot product matrix multiplication in order to produce a score matrix. The score matrix may determine the amount of focus for a word to be put on other words (thus, each word may be a score that corresponds to other words in the time-step). The values in score matrix may be scaled down. As a non-limiting example, score matrix may be divided by the square root of the dimension of the query and key vectors. In some embodiments, the softmax of the scaled scores in score matrix may be taken. The output of this softmax function may be called the attention weights. Attention weights may be multiplied by your value vector to obtain an output vector. The output vector may then be fed through a final linear layer.

Still referencing FIG. 1, in order to use self-attention in a multi-headed attention computation, query, key, and value may be split into N vectors before applying self-attention. Each self-attention process may be called a “head.” Each head may produce an output vector and each output vector from each head may be concatenated into a single vector. This single vector may then be fed through the final linear layer discussed above. In theory, each head can learn something different from the input, therefore giving the encoder model more representation power.

In some embodiments, and still referring to FIG. 1, one or more machine learning models used within system 100, such as the courage typing layer, the language processing module, or the scheduling machine learning model 140, may be implemented using a Q-former architecture. A “Q-former,” as used in this disclosure, is a transformer-based encoder-decoder structure that utilizes a fixed set of learnable query embeddings to selectively extract semantically relevant features from one or more input modalities. Unlike standard transformer attention mechanisms that attend exhaustively across all token positions, a Q-former may introduce an intermediate latent space through which the system can distill high-value information by attending from the learnable queries to pre-encoded input tokens. In some embodiments, the Q-former may be used to fuse multimodal inputs, such as natural language entries and image-based content (e.g., progress visualizations, scanned journal entries, or captured milestones). The query embeddings may attend to both textual and visual embeddings using cross-attention layers, allowing system 100 to learn modality-agnostic representations of user state, domain context, or motivational posture. These learned embeddings may then be passed downstream to one or more task-specific heads, such as courage-type classification, domain target prediction, or schedule generation. By incorporating Q-formers, system 100 may achieve more efficient and task-relevant information extraction from high-dimensional inputs, particularly in use cases involving multiple data modalities. For example, a Q-former-enabled courage classification model may use cross-attention to jointly consider semantic content from user journaling and image cues from uploaded progress artifacts. Similarly, a Q-former-based scheduling model may process domain-specific numerical summaries alongside user-authored goals or feedback, enabling more contextually aligned scheduling outcomes. The Q-former's constrained query mechanism may improve generalization, reduce redundancy in feature extraction, and enhance interpretability relative to standard full-attention transformer models.

With continued reference to FIG. 1, encoder of transformer may include a residual connection. Residual connection may include adding the output from multi-headed attention to the positional input embedding. In some embodiments, the output from residual connection may go through a layer normalization. In some embodiments, the normalized residual output may be projected through a pointwise feed-forward network for further processing. The pointwise feed-forward network may include a couple of linear layers with a ReLU activation in between. The output may then be added to the input of the pointwise feed-forward network and further normalized.

Continuing to refer to FIG. 1, transformer architecture may include a decoder. Decoder may a multi-headed attention layer, a pointwise feed-forward layer, one or more residual connections, and layer normalization (particularly after each sub-layer), as discussed in more detail above. In some embodiments, decoder may include two multi-headed attention layers. In some embodiments, decoder may be autoregressive. For the purposes of this disclosure, “autoregressive” means that the decoder takes in a list of previous outputs as inputs along with encoder outputs containing attention information from the input.

With further reference to FIG. 1, in some embodiments, input to decoder may go through an embedding layer and positional encoding layer in order to obtain positional embeddings. Decoder may include a first multi-headed attention layer, wherein the first multi-headed attention layer may receive positional embeddings.

With continued reference to FIG. 1, in some embodiments of the present invention, a first multi-headed attention layer within a decoder may be configured to prevent conditioning on future tokens during the generation of motivational prompts or courage-aligned coaching responses. For example, when the system is generating a user-facing coaching phrase such as “I am building momentum,” the decoder should not have access to the word “momentum” at the time it generates the word “am.” This constraint is particularly relevant in courage-phase-specific content generation, where reflective journaling prompts, check-in messages, or milestone validations must unfold in a temporally and semantically coherent manner. To enforce this constraint, a look-ahead mask may be implemented within the transformer architecture. The look-ahead mask may be a matrix with the same dimensions as the scaled attention score matrix and may include negative infinities in its upper-right triangle to prevent access to future tokens. For instance, the lower-left triangle of the masked score matrix may contain valid scaled attention scores, while the upper-right triangle is filled with negative infinities. When the softmax operation is applied, these infinities are suppressed to ensure that attention is limited to present and past tokens. This mechanism allows the system to generate courage-phase-specific feedback in a logically progressive fashion—e.g., building a reflection that encourages “Gain Clarity” before suggesting any commitments from the “Make Commitment” phase—while preserving natural language coherence and modeling temporal alignment with user state.

Still referring to FIG. 1, the second multi-headed attention layer may use encoder outputs as queries and keys and the outputs from the first multi-headed attention layer as values. This process matches the encoder's input to the decoder's input, allowing the decoder to decide which encoder input is relevant to put a focus on. The output from second multi-headed attention layer may be fed through a pointwise feedforward layer for further processing.

With continued reference to FIG. 1, the output of the pointwise feedforward layer may be fed through a final linear layer. This final linear layer may act as a classifier. This classifier may be as big as the number of classes that you have. For example, if you have 10,000 classes for 10,000 words, the output of that classifier will be of size 10,000. The output of this classifier may be fed into a softmax layer which may serve to produce probability scores between zero and one. The index may be taken of the highest probability score in order to determine a predicted word.

Still referring to FIG. 1, decoder may take this output and add it to the decoder inputs. Decoder may continue decoding until a token is predicted. Decoder may stop decoding once it predicts an end token.

Continuing to refer to FIG. 1, in some embodiment, decoder may be stacked N layers high, with each layer taking in inputs from the encoder and layers before it. Stacking layers may allow an LLM to learn to extract and focus on different combinations of attention from its attention heads.

With continued reference to FIG. 1, in some embodiments of the present invention, a large language model (LLM) may receive an input for the purpose of assessing user motivational state, classifying courage type, or generating personalized coaching dialogue. The input may include a string of one or more characters representing free-form natural language generated by the user. Inputs may also include unstructured data such as journaling entries, reflective responses, goal-setting statements, motivational queries, or milestone feedback. For example, input may consist of one or more words (e.g., “I'm stuck”), a sentence (e.g., “I want to try something new, but I'm nervous”), or a paragraph articulating current challenges or aspirations. A “query,” for purposes of this disclosure, is any text-based prompt or question directed to the system, such as “What should I focus on this week to move forward?” or “Why do I keep avoiding this task?” In some embodiments, input may be received from a user device, which may include, without limitation, a desktop computer, laptop, smartphone, tablet, or wearable device. Inputs may also include metadata associated with the user's current courage type, active domain, system deadlines, or content consumption history. In this context, the LLM may use the input not only to generate courage-type predictions or follow-up questions, but also to tailor its coaching tone, surface best-practice resources, or adjust system schedules and interventions accordingly.

With continued reference to FIG. 1, an LLM may generate at least one annotation as an output. At least one annotation may be any annotation as described herein. In some embodiments, an LLM may include multiple sets of transformer architecture as described above. Output may include a textual output. A “textual output,” for the purposes of this disclosure is an output comprising a string of one or more characters. Textual output may include, for example, a plurality of annotations for unstructured data. In some embodiments, textual output may include a phrase or sentence identifying the status of a user query. In some embodiments, textual output may include a sentence or plurality of sentences describing a response to a user query. As a non-limiting example, this may include restrictions, timing, advice, dangers, benefits, and the like.

Continuing to refer to FIG. 1, generating language processing model may include generating a vector space, which may be a collection of vectors, defined as a set of mathematical objects that can be added together under an operation of addition following properties of associativity, commutativity, existence of an identity element, and existence of an inverse element for each vector, and can be multiplied by scalar values under an operation of scalar multiplication compatible with field multiplication, and that has an identity element is distributive with respect to vector addition, and is distributive with respect to field addition. Each vector in an n-dimensional vector space may be represented by an n-tuple of numerical values. Each unique extracted word and/or language element as described above may be represented by a vector of the vector space. In an embodiment, each unique extracted and/or other language element may be represented by a dimension of vector space; as a non-limiting example, each element of a vector may include a number representing an enumeration of co-occurrences of the word and/or language element represented by the vector with another word and/or language element. Vectors may be normalized, scaled according to relative frequencies of appearance and/or file sizes. In an embodiment associating language elements to one another as described above may include computing a degree of vector similarity between a vector representing each language element and a vector representing another language element; vector similarity may be measured according to any norm for proximity and/or similarity of two vectors, including without limitation cosine similarity, which measures the similarity of two vectors by evaluating the cosine of the angle between the vectors, which can be computed using a dot product of the two vectors divided by the lengths of the two vectors. Degree of similarity may include any other geometric measure of distance between vectors.

Still referring to FIG. 1, language processing module may use a corpus of documents to generate associations between language elements in a language processing module, and diagnostic engine may then use such associations to analyze words extracted from one or more documents and determine that the one or more documents indicate significance of a category. In an embodiment, language module and/or [computing device] may perform this analysis using a selected set of significant documents, such as documents identified by one or more experts as representing good information; experts may identify or enter such documents via graphical user interface, or may communicate identities of significant documents according to any other suitable method of electronic communication, or by providing such identity to other persons who may enter such identifications into [computing device]. Documents may be entered into a computing device by being uploaded by an expert or other persons using, without limitation, file transfer protocol (FTP) or other suitable methods for transmission and/or upload of documents; alternatively or additionally, where a document is identified by a citation, a uniform resource identifier (URI), uniform resource locator (URL) or other datum permitting unambiguous identification of the document, diagnostic engine may automatically obtain the document using such an identifier, for instance by submitting a request to a database or compendium of documents such as JSTOR as provided by Ithaka Harbors, Inc. of New York.

In continued reference to FIG. 1, in operation, the courage typing layer may use one or more machine learning classifiers (e.g., random forest, SVM, neural network, or rule-based ensemble models) trained on labeled datasets of historical user journeys, courage-type transitions, and outcome correlations. The inferred courage type may be dynamically updated in response to changes in user data and may be passed as a feature input or modifier to other subsystems. For instance, the scheduling machine learning model 140 may use the active courage type to prioritize specific types of schedule components (e.g., deep-dive reflection sessions for Gain Clarity, bold public commitments for Make Commitment, unstructured exploration time for Be Creative). Similarly, the evaluating machine learning model 156 may adjust its interpretation of update data in light of the current courage state, for example, placing greater evaluative weight on ideation attempts during a Be Creative phase versus execution benchmarks during Achieve Consistency. The courage type may also modify GUI behavior, such as by tailoring tone, timing, and modality of coaching messages, or by triggering courage-aligned media assets from a curated content library. In some embodiments, system 100 may further modify a motivational feedback message as a function of the inferred courage type. Such modifications may include adjusting the content, tone, or delivery timing of prompts, reminders, or reflective queries in accordance with the user's current motivational posture. For example, a user inferred to be in the “Gain Clarity” phase may receive open-ended exploratory questions, while a user in the “Make Commitment” phase may be presented with assertive language encouraging specific action. These courage-informed modifications may improve engagement and alignment between motivational messaging and user readiness. This enables system 100 to function not only as a planner and evaluator, but as an intelligent motivational guide responsive to the user's evolving psychological state and growth phase.

In some embodiments, and with continued reference to FIG. 1, one or more machine learning models used in system 100, such as the courage classification model, scheduling machine learning model 140, or evaluating machine learning model 156, may be further trained or adapted using reinforcement learning techniques. “Reinforcement learning,” as used in this disclosure, is a learning framework in which an agent learns a decision-making policy by interacting with an environment and receiving feedback in the form of reward signals. In the context of system 100, the environment may include the user's evolving domain data, behavioral adherence patterns, feedback entries, and goal achievement status. For example, the courage classification model may act as a reinforcement learning agent that iteratively refines its predictions based on observed user transitions and outcome quality. A reward signal may be derived from successful alignment between inferred courage type and user progress toward domain targets, as captured in evaluation results 152 or subjective update data 148. In some embodiments, reinforcement learning may be used to fine-tune the scheduling machine learning model 140 to prioritize components that historically correlate with improved adherence or motivational engagement for a given user or cohort. In a non-limiting embodiment, system 100 may implement policy gradient methods, actor-critic frameworks, or Q-learning algorithms to update internal model policies. Alternatively, or additionally, system 100 may employ reinforcement learning from human feedback (RLHF), wherein user rankings or qualitative responses to generated schedules, prompts, or recommendations are used to train a reward model. The trained reward model may then inform ongoing policy updates, enabling models to align their outputs with real-world best practices, user satisfaction, or long-term goal attainment. This feedback-driven optimization mechanism may allow system 100 to dynamically improve personalization, motivational impact, and outcome relevance over time, even in non-stationary user environments.

In continued reference to FIG. 1, in an embodiment, computing device 104 may be further configured to generate at least an adaptive check-in point as a function of a system time constraint and the inferred courage type. For purposes of this disclosure, a “system time constraint” a temporal limitation or boundary condition that influences the generation or modification of a user schedule. A time constraint may include, without limitation, one or more scheduling limitations derived from user-defined availability, system-assigned deadlines, calendar conflicts, recurring obligations, or temporal milestones associated with domain targets. In some embodiments, time constraints may be extracted or inferred from scheduling data 112, such as calendar entries, blocked time segments, or user-input deadlines. Time constraints may be used by system 100 to determine feasible time windows for inserting schedule components or adaptive check-in points and may serve to prioritize certain actions based on proximity to an upcoming milestone or user availability. In some embodiments, this functionality may be implemented through adaptive scheduling logic that generates customized check-in points based on user-defined or system-assigned deadlines (e.g., weekly, monthly, or quarterly) and the currently inferred courage type. For example, when a user is classified as being in a Gain Clarity phase with a monthly milestone target, system 100 may schedule intermediate check-ins focused on investigative tasks or self-assessment prompts during the early portion of the period. In contrast, a user in a Make Commitment or Achieve Consistency phase may receive more frequent accountability reminders or behavioral nudges as the deadline approaches. The courage typing layer may dynamically influence both the timing and nature of these check-ins by modifying scheduling parameters or priority weightings within the scheduling machine learning model 140. Additionally, system 100 may use historical response patterns, missed tasks, or engagement data to further personalize these checkpoints, optimizing for both user receptivity and goal proximity. This adaptive check-in strategy allows system 100 to support user momentum across varied courage states while maintaining alignment with external or self-imposed time constraints.

Whether implemented as a model layer or as a dedicated courage classification model, system 100 may surface the inferred courage type to the user through a graphical user interface (e.g., in the form of suggested actions, icons, taglines, or prompts), or may use the output internally to adapt domain targets, adjust schedule prioritization, or influence the content and tone of motivational messaging. In some embodiments, the courage type may be visualized as a current position within an infinity loop, with directional progression toward a goal. The system may reference the courage type when curating best-practice content, such as videos, audio guidance, reading material, or coaching prompts, and may engage in dialog or questioning to help the user refine their position, confirm completion of associated milestone steps, or transition to the next courage state. Deadlines (e.g., this week, month, quarter) may also be considered in the system's check-in strategy and personalization logic. The courage inference system may thereby enable enhanced motivation alignment and adaptive engagement tailored to the user's readiness, domain status, and vision trajectory.

With further reference to FIG. 1, in some embodiments, system 100 may further monitor a sequence of inferred courage types for a given user over time. This sequence may be stored as part of a user-specific motivational profile and may reflect the user's historical transitions across the predefined courage types. System 100 may detect courage-type transitions, including forward progressions, regressions, or eliminator-triggered resets, by comparing current and previous courage type classifications. In an embodiment, in response to detecting one or more transitions, system 100 may trigger a retraining or fine-tuning process of the courage typing layer using the user's historical transition data as input. For example, if a user repeatedly transitions from “Be Creative” to “Stagnation,” the system may adjust the weighting of features in the classifier to increase sensitivity to early indicators of creative burnout. The retraining process may occur asynchronously, periodically, or in real time, and may be implemented as part of an online learning framework or episodic model refinement workflow.

In further reference to FIG. 1, in some embodiments, system 100 may further include or interface with a content delivery engine configured to serve curated or dynamically generated resources aligned with the user's currently inferred courage type. The content delivery engine may access a library of media including, but not limited to, video content, audio recordings, written articles, guided prompts, and domain-specific best practices. In some embodiments, content items may be indexed or tagged by courage type, domain context, or milestone objective, allowing the system to match appropriate materials to the user's current position in the courage loop. In an exemplary embodiment, system 100 may detect that a user is in the Be Creative phase within the vocational domain and retrieve a set of creativity-focused prompts, expert videos, and iterative task templates drawn from the content library to support forward momentum. The system may further engage the user in guided dialogue (e.g., through automated questioning, reflective journaling, or voice/text prompts) to help the user unpack their current status, refine their intention, and surface specific actions needed to transition to the next courage phase. In some cases, system 100 may verify whether sufficient specificity or action has been taken to justify transitioning to a subsequent courage type. This verification may be based on input completeness, user-generated goals, achievement of predefined criteria, or subjective feedback. For example, if a user in the Gain Clarity phase completes a structured reflection exercise and identifies specific resource gaps, the system may determine that a threshold for clarity has been met and suggest transition to Make Commitment. The content engine may also track which content elements have been completed, partially consumed, or skipped, and use this data, along with time-based engagement, feedback scores, or completion tags, as features for retraining the courage classification model or for adjusting future content recommendations. This interactive and data-responsive coaching framework may allow system 100 to guide users through a validated best-practice pathway toward milestone completion and ultimate domain flourishing.

Referring now to FIG. 2, exemplary domains 200 are illustrated by way of a table. As can be seen domains may include vocational 204, marriage 208, family 212, health 216, virtue 220, emotional 224, financial 228, spiritual 232, intellectual 236, lifestyle 240, interest 244, and social 248 to name a few. Each domain 200 may have a status. Exemplary, non-limiting statuses include breakthrough, emerging, growth, plateau, stagnation, and depletion to name a few. In some cases, a domain status may be determined according to one or more state variables. State variable may be affected by objective data and/or subjective data. Exemplary non-limiting examples of objective data include medical measurements, time spent on certain activities, events participated in, number of steps taken, and generally speaking anything that can be measured. In some cases, remote device may directly measure or infer objective data, for example remote device may measure number of steps taken by user, amount of screen time, and the like. Alternatively or additionally objective data may be input by user into remote device. For example, a user may include user weight, user blood pressure, or any other objective datum by way of remote device. In some cases, user may input subjective data, for example by way of remote device. Subjective data may include a numerical representation (e.g., 1-10 rating) of how a user thinks or feels about a current aspect relating to a domain. For example a user may rate a level of anxiety, a level of fulfilment, or the like. In an embodiment, one or more domains may be selected and/or isolated by a user. This may allow for a more focused and concentrated experience on one or more domains of interest to a user. In an embodiment, a user may select one or more domains to isolate and/or focus on. In yet another non-limiting example, computing device 104 may select one or more domains for a user to focus on, using a selection process that may include one or more machine learning processes as described throughout this application.

With continued reference to FIG. 2, at least a domain may include vocational domain 204. Objective data that may be associated with vocational domain includes title, role, responsibility, compensation, and the like. Subjective data may include a rating of user's level of vocational fulfilment. A domain target associated with vocational domain 204 may include a change in a subjective or objective datum associated with the vocational domain 204. Schedule components or events that may be added to exploit value in vocational domain 204 include professional training events, maximizing contribution, exploiting opportunities, and the like.

With continued reference to FIG. 2, at least a domain may include marriage domain 208. Objective data that may be associated with marriage domain includes amount of time spent with spouse, for example time spent enjoying one another. Subjective data may include a rating of user's level of marriage fulfilment. A domain target associated with marriage domain 208 may include a change in a subjective or objective datum associated with the marriage domain 208. Schedule components or events that may be added to exploit value in marriage domain 208 include events determined to maximize marriage fulfilment, including participating in couple centric events, self-sacrificial acts of love, couples therapy, honest communication sessions, and the like.

With continued reference to FIG. 2, at least a domain may include family domain 212. Objective data that may be associated with family domain includes amount of time spent with family. Subjective data may include a rating of user's level of family fulfilment or a rating of a family member's level of fulfilment with user/spouse. A domain target associated with family domain 212 may include a change in a subjective or objective datum associated with the family domain 212. Schedule components or events that may be added to exploit value in family domain 212 include events determined to maximize family fulfilment, including participating in family events, self-sacrificing acts of love, generosity of time, money, and service, and the like.

With continued reference to FIG. 2, at least a domain may include health domain 216. Objective data that may be associated with health domain includes medical data, such as without limitation body mass index, blood pressure, resting heart rate, blood oxygen content, and the like. Subjective data may include a rating of user's level of health fulfilment, a rating of number of activities a user feels are impaired by health concerns, a rating of overall concern with health, and the like. A domain target associated with health domain 216 may include a change in a subjective or objective datum associated with the health domain 216. Schedule components or events that may be added to exploit value in health domain 216 include events determined to maximize health fulfilment, exercise, nutritional meals, visits to medical professionals, and the like.

With continued reference to FIG. 2, at least a domain may include virtue domain 208. Objective data that may be associated with virtue domain includes amount of time acting virtuously, proportion of big decisions which are aligned with desirable virtues, amount of success or failure living within targeted virtue levels, evidence of retained or unretained resolve, and the like. Subjective data may include a rating of user's self-perceived level of virtue or a rating of user's perceived level of virtue from another. A domain target associated with virtue domain 220 may include a change in a subjective or objective datum associated with the virtue domain 220. Schedule components or events that may be added to exploit value in virtue domain 220 include events determined to maximize virtue fulfilment, including participating habit building exercises designed to facilitate consistently good decision making.

With continued reference to FIG. 2, at least a domain may include emotional domain 224. Objective data that may be associated with emotional domain includes amount of time spent in a state of emotional destress, amount of time in emotional harmony, amount of time sleeping, caloric intake, amount of time engaged in anxiety about the past or imagined future, and the like. Subjective data may include a rating of user's level of emotional fulfilment. A domain target associated with emotional domain 224 may include a change in a subjective or objective datum associated with the emotional domain 224. Schedule components or events that may be added to exploit value in emotional domain 224 include therapy, treatment under the supervision of health care professionals, events and exercises that are likely to improve a user's emotions, and the like.

With continued reference to FIG. 2, at least a domain may include financial domain 228. Objective data that may be associated with financial domain includes amount of financial assets possessed by user. Subjective data may include a rating of user's sense of financial security independence and freedom. A domain target associated with financial domain 228 may include a change in a subjective or objective datum associated with the financial domain 228. Schedule components or events that may be added to exploit value in financial domain 228 include meeting with a financial advisor, increasing savings contributions, budgeting, and the like.

With continued reference to FIG. 2, at least a domain may include intellectual domain 236. Objective data that may be associated with intellectual domain includes amount performance in intellectual pursuits, such as graded performance in school. Subjective data may include a rating of user's level of intellectual fulfilment. A domain target associated with intellectual domain 236 may include a change in a subjective or objective datum associated with the intellectual domain 236. Schedule components or events that may be added to exploit value in intellectual domain 236 include events determined to maximize intellectual fulfilment, including enrolling in educational programs, enjoying cultural events, and the like.

With continued reference to FIG. 2, at least a domain may include lifestyle domain 240. Objective data that may be associated with lifestyle domain includes amount of time spent in ideal or unideal lifestyle settings. Subjective data may include a rating of user's level of lifestyle fulfilment. A domain target associated with lifestyle domain 240 may include a change in a subjective or objective datum associated with the lifestyle domain 240. Schedule components or events that may be added to exploit value in lifestyle domain 240 include events determined to maximize lifestyle fulfilment, including housing, travel, wardrobe, toys, activities, groups and free time.

With continued reference to FIG. 2, at least a domain may include interest domain 244. Objective data that may be associated with interest domain includes amount of time on avocational pursuits or personally enjoyable activities. Subjective data may include a rating of user's level of interest fulfilment. A domain target associated with interest domain 244 may include a change in a subjective or objective datum associated with the interest domain 244. Schedule components or events that may be added to exploit value in interest domain 244 include events determined to maximize interest fulfilment, including hobbyist events, and the like.

With continued reference to FIG. 2, at least a domain may include social domain 248. Objective data that may be associated with social domain includes amount of time spent with others in a social setting, for example time spent enjoying one another. Subjective data may include a rating of user's level of social fulfilment. A domain target associated with social domain 248 may include a change in a subjective or objective datum associated with the social domain 248. Schedule components or events that may be added to exploit value in social domain 248 include events determined to maximize social fulfilment, including participating in social events, engaging with a club, friends, groups, entertainment events, and the like.

Referring now to FIG. 3A, an exemplary remote device 300 is illustrated. In some cases, remote device 300 may interface with user by way of a graphical user interface (GUI) 304. In some cases, remote device 300 may display to user a schedule 308, such as without limitation a weekly schedule. In some cases, schedule 308 function allows a user to view and edit a user schedule. In some cases, remote device 300 may display to user domains 312a-1. In some cases, progress (e.g., evaluation results) related to a domain may be represented by GUI, such as by way of color coding. For example, family domain 312c is indicated with hashmarks to indicate that family is an undesirable (e.g., depleted) status. In some cases, a status for each domain may be indicated to user by way of GUI 304, for example in an “Insight” view 324. In some cases, GUI may allow user access to resources. In some cases, resources may be domain specific. Exemplary resources include podcasts and courses. Podcasts may include any audio information designed to enrich a user, for example within a specific domain. Courses may include any media, such as video, text, and the like intended to enrich a user, for example within a specific domain. Breakthrough 328 may isolate one or more domains that may aid in a more focused and concentrated experience to assist in driving change and progress. Solve 332 may include a scheduled focus for a particular period of time such as a day, week, month, quarter, year, and the like. Solve 332 may display information pertaining to particular issues and problems to solve and may aid in selecting one or more breakthrough domains. Sprint 336 may include habits, projects, and to dos that may be aligned with a user's priorities and interests. Overview 340 may include a big picture view of domains, realms, and/or categories. Notebook and/or intelligence tabs may include one or more digital copies of handwritten tools that may be integrated and automatically updated and available within graphical user interface 304. In some embodiments, GUI 304 may include a guidance view 320. Guidance view 320 may cause GUI 304 to display a guidance view including guidance to a user when the user clicks on the corresponding button. In some embodiments, GUI 304 may include a home button 316. Home button 316 may allow a user to return to a home or default view when clicked.

Referring now to FIG. 3B, an exemplary remote device 300 is illustrated. In some cases, remote device 300 may interface with user by way of a graphical user interface (GUI) 304. In some cases, remote device 300 may display domain-specific information 352, for instance information related to health domain. In some cases, an overall domain-specific rating 356 (i.e., evaluation result) may be presented to user. Additionally, subordinate domain-specific ratings (i.e., evaluation results) 360a-g may be presented to user. For example, subordinate domain-specific ratings may be related to mode 360a, resolve 360b, learning 360c, support 360d, direction 360e, guardrail 360f, action 360g, and the like. In some cases, a domain may be prioritize, for example with an overall priority 364a and/or a breakthrough priority 364b. In some cases, domain-specific information may be enumerated and/or prioritized. Exemplary enumerations and/or prioritizations include without limitation big breakthroughs 368, biggest vulnerability to eliminate 372, biggest opportunity to capture 376, opportunities for improvement/enjoyment/gain 380, and the like.

Referring now to FIGS. 3C and 3D, an exemplary remote device 300 display is illustrated. In some instances, remote device 300 may interface with user by way of a graphical user interface (GUI) 304. In some cases, remote device 300 may display suggestions such as “Habits/Productivity hacks,” “Rocks,” “Issues & Problems to Solve,” or the like. Each suggestion category may include at least a domain with a respective drop-down menu option. In some instances, at least a domain may be color coded to indicate a domain-specific rating. As a non-limiting example, at least a domain may be a green shade if a respective domain-specific rating is above a certain threshold (e.g., 7.1). Further, at least a domain may be a yellow shade if a respective domain specific rating is below a certain threshold (e.g., 7.0). Further, at least a domain may be a red shade if a respective domain specific rating is below a certain threshold (e.g., 6.0). In some embodiments, the threshold for the red shade may be lower than the threshold for the yellow and/or green shade. For example, the threshold for the red shade may be 6.0 while the threshold for the yellow shade may be 7.0. A person of ordinary skill in the art, having reviewed the entirety of this disclosure, would appreciate that the colors of red/yellow/green are merely exemplary and different colors and/or color spectrums could be chosen to suit different color schemes or purposes.

Continuing to refer to FIGS. 3C and 3D, at least a domain drop-down menu may include one or more recommendations and/or one or more suggestions associated with the suggestion category and the at least a domain. As a non-limiting example, a drop-down menu for “Vocational Well-Being” under the “Habits/Productivity Hacks” suggestion category may include habits and/or productivity hacks to improve a user's vocational well-being. Continuing the non-limiting example, habits and/or productivity hacks to improve the user's vocational well-being may include organizational suggestions, suggested modification to hours, prioritizing the user's work tasks based on predetermined importance, or the like.

Now referring to FIG. 3E, an exemplary remote device 300 is illustrated. In some cases, remote device 300 may interface with user by way of a graphical user interface (GUI) 304. In some cases, remote device 300 may display to user a schedule 308, such as without limitation a weekly schedule. In some cases, schedule 308 function allows a user to view and edit a user schedule. In some cases, remote device 300 may display to user domains 312a-1. In some cases, progress (e.g., evaluation results) related to a domain may be represented by GUI, such as by way of color coding. For example, family domain 312c is indicated with hashmarks to indicate that family is an undesirable (e.g., depleted) status. In some cases, a status for each domain may be indicated to user by way of GUI 304, for example in an “Insight” view 324. In some cases, GUI may allow user access to resources. In some cases, resources may be domain specific. Exemplary resources include podcasts and courses. Podcasts may include any audio information designed to enrich a user, for example within a specific domain. Courses may include any media, such as video, text, and the like intended to enrich a user, for example within a specific domain. Focus 328c may isolate one or more domains that may aid in a more focused and concentrated experience to assist in driving change and progress. Courage 332e may include a scheduled focus for a particular period of time such as a day, week, month, quarter, year, and the like. Courage 332e may display information pertaining to particular issues and problems to solve and may aid in selecting one or more breakthrough domains. Sprint 336 may include habits, projects, and to dos that may be aligned with a user's priorities and interests. Clarity 340e may include a big picture view of domains, realms, and/or categories. Notebook and/or intelligence tabs may include one or more digital copies of handwritten tools that may be integrated and automatically updated and available within graphical user interface 304. In some embodiments, GUI 304 may include a guidance view 320. Guidance view 320 may cause GUI 304 to display a guidance view including guidance to a user when the user clicks on the corresponding button. In some embodiments, GUI 304 may include a home button 316. Home button 316 may allow a user to return to a home or default view when clicked.

Referring now to FIG. 3F, an exemplary remote device 300 display is illustrated. In some instances, remote device 300 may interface with user by way of a graphical user interface (GUI) 304. In some cases, remote device 300 may when a courage tab is selected, display suggestions or track metrics such as “Courage This Week,” “Courage This Month,” “Courage This Quarter,” “Courage This Year,” “Courage This Decade,” “Courage This Lifetime,” or the like. Each suggestion category may include at least a domain with a respective drop-down menu option. In some instances, at least a domain may be color coded to indicate a domain-specific rating. As a non-limiting example, at least a domain may be a green shade if a respective domain-specific rating is above a certain threshold (e.g., 7.1). Further, at least a domain may be a yellow shade if a respective domain specific rating is below a certain threshold (e.g., 7.0). Further, at least a domain may be a red shade if a respective domain specific rating is below a certain threshold (e.g., 6.0). In some embodiments, the threshold for the red shade may be lower than the threshold for the yellow and/or green shade. For example, the threshold for the red shade may be 6.0 while the threshold for the yellow shade may be 7.0. A person of ordinary skill in the art, having reviewed the entirety of this disclosure, would appreciate that the colors of red/yellow/green are merely exemplary and different colors and/or color spectrums could be chosen to suit different color schemes or purposes.

Continuing to refer to FIG. 3F, at least a domain drop-down menu may include one or more recommendations and/or one or more suggestions associated with the suggestion category and the at least a domain. As a non-limiting example, a drop-down menu for “Vocational Well-Being” under the “Courage This Week” suggestion category may suggest courage types or related activities to improve a user's vocational well-being. Continuing the non-limiting example, courage types and/or related activities to improve the user's vocational well-being may include organizational suggestions, suggested modification to hours, prioritizing the user's work tasks based on predetermined importance, implementing a courage type, or the like.

Now referring to FIG. 3G, an exemplary remote device 300 display is illustrated. In some instances, remote device 300 may interface with user by way of a graphical user interface (GUI) 304. In some cases, remote device 300 may when a flow tab is selected, display suggestions or track metrics such as “Rock Multiplier,” “Habit Multiplier,” “EEDAP Multiplier,” “Achievement Multiplier,” “Collaboration Multiplier,” “Talent Multiplier,” “Mastermind Multiplier,” “Vice Eliminator,” “Stagnation/Depletion Eliminator,” or the like. Each suggestion category may include at least a domain with a respective drop-down menu option. In some instances, at least a domain may be color coded to indicate a domain-specific rating. As a non-limiting example, at least a domain may be a green shade if a respective domain-specific rating is above a certain threshold (e.g., 7.1). Further, at least a domain may be a yellow shade if a respective domain specific rating is below a certain threshold (e.g., 7.0). Further, at least a domain may be a red shade if a respective domain specific rating is below a certain threshold (e.g., 6.0). In some embodiments, the threshold for the red shade may be lower than the threshold for the yellow and/or green shade. For example, the threshold for the red shade may be 6.0 while the threshold for the yellow shade may be 7.0. A person of ordinary skill in the art, having reviewed the entirety of this disclosure, would appreciate that the colors of red/yellow/green are merely exemplary and different colors and/or color spectrums could be chosen to suit different color schemes or purposes.

Referring now to FIG. 4, an exemplary embodiment of a machine-learning module 400 that may perform one or more machine-learning processes as described in this disclosure is illustrated. Machine-learning module may perform determinations, classification, and/or analysis steps, methods, processes, or the like as described in this disclosure using machine learning processes. A “machine learning process,” as used in this disclosure, is a process that automatedly uses training data 404 to generate an algorithm that will be performed by a computing device/module to produce outputs 408 given data provided as inputs 412; this is in contrast to a non-machine learning software program where the commands to be executed are determined in advance by a user and written in a programming language.

Still referring to FIG. 4, “training data,” as used herein, is data containing correlations that a machine-learning process may use to model relationships between two or more categories of data elements. For instance, and without limitation, training data 404 may include a plurality of data entries, each entry representing a set of data elements that were recorded, received, and/or generated together; data elements may be correlated by shared existence in a given data entry, by proximity in a given data entry, or the like. Multiple data entries in training data 404 may evince one or more trends in correlations between categories of data elements; for instance, and without limitation, a higher value of a first data element belonging to a first category of data element may tend to correlate to a higher value of a second data element belonging to a second category of data element, indicating a possible proportional or other mathematical relationship linking values belonging to the two categories. Multiple categories of data elements may be related in training data 404 according to various correlations; correlations may indicate causative and/or predictive links between categories of data elements, which may be modeled as relationships such as mathematical relationships by machine-learning processes as described in further detail below. Training data 404 may be formatted and/or organized by categories of data elements, for instance by associating data elements with one or more descriptors corresponding to categories of data elements. As a non-limiting example, training data 404 may include data entered in standardized forms by persons or processes, such that entry of a given data element in a given field in a form may be mapped to one or more descriptors of categories. Elements in training data 404 may be linked to descriptors of categories by tags, tokens, or other data elements; for instance, and without limitation, training data 404 may be provided in fixed-length formats, formats linking positions of data to categories such as comma-separated value (CSV) formats and/or self-describing formats such as extensible markup language (XML), JavaScript Object Notation (JSON), or the like, enabling processes or devices to detect categories of data.

Alternatively, or additionally, and continuing to refer to FIG. 4, training data 404 may include one or more elements that are not categorized; that is, training data 404 may not be formatted or contain descriptors for some elements of data. Machine-learning algorithms and/or other processes may sort training data 404 according to one or more categorizations using, for instance, natural language processing algorithms, tokenization, detection of correlated values in raw data and the like; categories may be generated using correlation and/or other processing algorithms. As a non-limiting example, in a corpus of text, phrases making up a number “n” of compound words, such as nouns modified by other nouns, may be identified according to a statistically significant prevalence of n-grams containing such words in a particular order; such an n-gram may be categorized as an element of language such as a “word” to be tracked similarly to single words, generating a new category as a result of statistical analysis. Similarly, in a data entry including some textual data, a person's name may be identified by reference to a list, dictionary, or other compendium of terms, permitting ad-hoc categorization by machine-learning algorithms, and/or automated association of data in the data entry with descriptors or into a given format. The ability to categorize data entries automatedly may enable the same training data 404 to be made applicable for two or more distinct machine-learning algorithms as described in further detail below. Training data 404 used by machine-learning module 400 may correlate any input data as described in this disclosure to any output data as described in this disclosure. As a non-limiting illustrative example input may include domain-specific data and outputs may include correlated domain targets. Alternatively, or additionally, inputs may include scheduling data and at least a domain target correlated to outputs that include schedule components or user schedules. Alternatively, or additionally, inputs may include update data and/or domains correlated to evaluations.

Further referring to FIG. 4, training data may be filtered, sorted, and/or selected using one or more supervised and/or unsupervised machine-learning processes and/or models as described in further detail below; such models may include without limitation a training data classifier 416. Training data classifier 416 may include a “classifier,” which as used in this disclosure is a machine-learning model as defined below, such as a mathematical model, neural net, or program generated by a machine learning algorithm known as a “classification algorithm,” as described in further detail below, that sorts inputs into categories or bins of data, outputting the categories or bins of data and/or labels associated therewith. A classifier may be configured to output at least a datum that labels or otherwise identifies a set of data that are clustered together, found to be close under a distance metric as described below, or the like. Machine-learning module 400 may generate a classifier using a classification algorithm, defined as a process whereby a computing device and/or any module and/or component operating thereon derives a classifier from training data 404. Classification may be performed using, without limitation, linear classifiers such as without limitation logistic regression and/or naive Bayes classifiers, nearest neighbor classifiers such as k-nearest neighbors classifiers, support vector machines, least squares support vector machines, fisher's linear discriminant, quadratic classifiers, decision trees, boosted trees, random forest classifiers, learning vector quantization, and/or neural network-based classifiers. As a non-limiting example, training data classifier 416 may classify elements of training data to a particular domain, user, or user cohort. For example, in some cases, any machine-learning model described herein may be trained and/or retrained specifically with training data that is representative only of a particular domain, a particular user, or a cohort.

Still referring to FIG. 4, machine-learning module 400 may be configured to perform a lazy-learning process 420 and/or protocol, which may alternatively be referred to as a “lazy loading” or “call-when-needed” process and/or protocol, may be a process whereby machine learning is conducted upon receipt of an input to be converted to an output, by combining the input and training set to derive the algorithm to be used to produce the output on demand. For instance, an initial set of simulations may be performed to cover an initial heuristic and/or “first guess” at an output and/or relationship. As a non-limiting example, an initial heuristic may include a ranking of associations between inputs and elements of training data 404. Heuristics may include selecting some number of highest-ranking associations and/or training data 404 elements. Lazy learning may implement any suitable lazy learning algorithm, including without limitation a K-nearest neighbors algorithm, a lazy naïve Bayes algorithm, or the like; persons skilled in the art, upon reviewing the entirety of this disclosure, will be aware of various lazy-learning algorithms that may be applied to generate outputs as described in this disclosure, including without limitation lazy learning applications of machine-learning algorithms as described in further detail below.

Alternatively, or additionally, and with continued reference to FIG. 4, machine-learning processes as described in this disclosure may be used to generate machine-learning models 424. A “machine-learning model,” as used in this disclosure, is a mathematical and/or algorithmic representation of a relationship between inputs and outputs, as generated using any machine-learning process including without limitation any process as described above and stored in memory; an input is submitted to a machine-learning model 424 once created, which generates an output based on the relationship that was derived. For instance, and without limitation, a linear regression model, generated using a linear regression algorithm, may compute a linear combination of input data using coefficients derived during machine-learning processes to calculate an output datum. As a further non-limiting example, a machine-learning model 424 may be generated by creating an artificial neural network, such as a convolutional neural network comprising an input layer of nodes, one or more intermediate layers, and an output layer of nodes. Connections between nodes may be created via the process of “training” the network, in which elements from a training data 404 set are applied to the input nodes, a suitable training algorithm (such as Levenberg-Marquardt, conjugate gradient, simulated annealing, or other algorithms) is then used to adjust the connections and weights between nodes in adjacent layers of the neural network to produce the desired values at the output nodes. This process is sometimes referred to as deep learning.

Still referring to FIG. 4, machine-learning algorithms may include at least a supervised machine-learning process 428. At least a supervised machine-learning process 428, as defined herein, include algorithms that receive a training set relating a number of inputs to a number of outputs, and seek to find one or more mathematical relations relating inputs to outputs, where each of the one or more mathematical relations is optimal according to some criterion specified to the algorithm using some scoring function. For instance, a supervised learning algorithm may include inputs as described above as inputs, outputs as outputs, and a scoring function representing a desired form of relationship to be detected between inputs and outputs; scoring function may, for instance, seek to maximize the probability that a given input and/or combination of elements inputs is associated with a given output to minimize the probability that a given input is not associated with a given output. Scoring function may be expressed as a risk function representing an “expected loss” of an algorithm relating inputs to outputs, where loss is computed as an error function representing a degree to which a prediction generated by the relation is incorrect when compared to a given input-output pair provided in training data 404. Persons skilled in the art, upon reviewing the entirety of this disclosure, will be aware of various possible variations of at least a supervised machine-learning process 428 that may be used to determine relation between inputs and outputs. Supervised machine-learning processes may include classification algorithms as defined above.

Further referring to FIG. 4, machine learning processes may include at least an unsupervised machine-learning processes 432. An unsupervised machine-learning process, as used herein, is a process that derives inferences in datasets without regard to labels; as a result, an unsupervised machine-learning process may be free to discover any structure, relationship, and/or correlation provided in the data. Unsupervised processes may not require a response variable; unsupervised processes may be used to find interesting patterns and/or inferences between variables, to determine a degree of correlation between two or more variables, or the like.

Still referring to FIG. 4, machine-learning module 400 may be designed and configured to create a machine-learning model 424 using techniques for development of linear regression models. Linear regression models may include ordinary least squares regression, which aims to minimize the square of the difference between predicted outcomes and actual outcomes according to an appropriate norm for measuring such a difference (e.g. a vector-space distance norm); coefficients of the resulting linear equation may be modified to improve minimization. Linear regression models may include ridge regression methods, where the function to be minimized includes the least-squares function plus term multiplying the square of each coefficient by a scalar amount to penalize large coefficients. Linear regression models may include least absolute shrinkage and selection operator (LASSO) models, in which ridge regression is combined with multiplying the least-squares term by a factor of 1 divided by double the number of samples. Linear regression models may include a multi-task lasso model wherein the norm applied in the least-squares term of the lasso model is the Frobenius norm amounting to the square root of the sum of squares of all terms. Linear regression models may include the clastic net model, a multi-task elastic net model, a least angle regression model, a LARS lasso model, an orthogonal matching pursuit model, a Bayesian regression model, a logistic regression model, a stochastic gradient descent model, a perceptron model, a passive aggressive algorithm, a robustness regression model, a Huber regression model, or any other suitable model that may occur to persons skilled in the art upon reviewing the entirety of this disclosure. Linear regression models may be generalized in an embodiment to polynomial regression models, whereby a polynomial equation (e.g. a quadratic, cubic or higher-order equation) providing a best predicted output/actual output fit is sought; similar methods to those described above may be applied to minimize error functions, as will be apparent to persons skilled in the art upon reviewing the entirety of this disclosure.

Continuing to refer to FIG. 4, machine-learning algorithms may include, without limitation, linear discriminant analysis. Machine-learning algorithm may include quadratic discriminate analysis. Machine-learning algorithms may include kernel ridge regression. Machine-learning algorithms may include support vector machines, including without limitation support vector classification-based regression processes. Machine-learning algorithms may include stochastic gradient descent algorithms, including classification and regression algorithms based on stochastic gradient descent. Machine-learning algorithms may include nearest neighbors algorithms. Machine-learning algorithms may include various forms of latent space regularization such as variational regularization. Machine-learning algorithms may include Gaussian processes such as Gaussian Process Regression. Machine-learning algorithms may include cross-decomposition algorithms, including partial least squares and/or canonical correlation analysis. Machine-learning algorithms may include naïve Bayes methods. Machine-learning algorithms may include algorithms based on decision trees, such as decision tree classification or regression algorithms. Machine-learning algorithms may include ensemble methods such as bagging meta-estimator, forest of randomized tress, AdaBoost, gradient tree boosting, and/or voting classifier methods. Machine-learning algorithms may include neural net algorithms, including convolutional neural net processes.

With continued reference to FIG. 4, in some embodiments, machine-learning module 400 may be configured to perform automated planning and scheduling. In some cases, automated planning may require iterative processes, allowing feedback (e.g., user input, such as a scheduling change request) to affect planning. In some cases, a planner may input a domain model (a description of a set of possible actions which model the domain) for a single domain as well as a specific problem to be solved specified by, for instance, by an initial state and a goal (e.g., domain target), in contrast to those in which there is no input domain or multiple input domains are specified. Such planners may be called domain independent, as they can solve planning problems from a wide range of domains. Typical examples of domains are described above in reference to FIG. 2. Hence a single domain-independent planner can be used to solve planning problems in all domains and thereby generate a user schedule. In some cases, a maximum number of domains may be constrained by increased complexity in scheduling or planning. In some cases, status within at least a domain may be represented by one or more state variables. Each possible status of at least a domain may be represented by an assignment of values to state variables, and scheduled events (e.g., actions) may determine how the values of the state variables change when that planned schedule event occurs. As a set of state variables induce a state space that has a size that may grow exponentially, planning, and number of maximum number of domains may be constrained to avoid runaway complexity (e.g., dimensional complexity and combinatorial complexity). A number of algorithms and approaches may be used for automated planning.

With continued reference to FIG. 4, exemplary non-limiting approaches for planning include classical planning, reduction to other problems, temporal planning, probabilistic planning, preference-based planning, conditional planning (e.g., contingent planning and conformant planning), and the like. In some cases, classical planning may include a known initial state, deterministic events, non-simultaneous events, and events that are singularly attended to by user. A deterministic event may be expected to change a status (i.e., state variable) of a domain in a predictable way. In some cases, classical planning may include forward chaining state space search, backward chaining search, and partial-order planning. classical planning approaches may be, in some cases, enhanced and/or simplified with heuristics, state constraints, and the like.

With continued reference to FIG. 4, an automated planning algorithm may include a reduction to other problems. In some cases, a reduction to other problems may include reducing planning to a satisfiability problem (e.g., Boolean satisfiability problem). This may be referred to as Planning as Satisfiability (satplan). Exemplary non-limiting satplan algorithms include Davis-Putnam-Logemann-Loveland (DPLL) algorithm, GSAT, and WalkSAT. In some cases, reduction to other problems may include reduction to model checking. Model checking reduction to other problems may include traversing at least a state space and checking to ensure correctness against a given specification.

With continued reference to FIG. 4, an automated planning algorithm may include a temporal planning approach. In some cases, temporal planning can be solved with methods similar to classical planning. Temporal planning may additionally account for a possibility of temporally overlapping events or actions with a duration being taken concurrently. As a result, temporal planning algorithms may define a state to include information about a current absolute time and for how long each event has proceeded. Temporal planning may schedule plans relative rational or real time, or with integer time.

With continued reference to FIG. 4, an automated planning algorithm may include a probabilistic planning approach. Exemplary non-limiting methods of probabilistic planning may include Markov decision processes and/or partially observable Markov decision processes. In some case, probabilistic planning can be solved with iterative methods such as value iteration and policy iteration, for example when state space is sufficiently small. With partial observability, probabilistic planning may be similarly solved with iterative methods, but using a representation of value functions defined for space of beliefs instead of states.

With continued reference to FIG. 4, an automated planning algorithm may include preference-based planning. In preference-based planning, a schedule may be generated that satisfies user-specified preferences. For example, in some cases, a user may input preferences, such as a prioritization of one domain over another, a preference to have certain events at certain times, a preference for certain events to occur on different days, and the like. In some cases, a preference may have a numerical value. In which cases, a Markov Decision Processes (MDP) may be used (i.e., reward-based planning). Alternatively or additionally, in some cases, a user preference may not have a precise numerical value.

With continued reference to FIG. 4, an automated planning algorithm may include conditional planning. In some cases, conditional planning may include hierarchical planning, which may be compared with an automatic generated behavior tree. A normal behavior tree may allow for loops or if-then-statements. Conditional planning may overcome this and allow of these conditions within the automated planning process. In some cases, a planner may synthesize a program, which may then be run in order to generate user schedule. Exemplary non-limiting conditional planner includes “Warplan-C.” In some cases, conditional planning may allow for uncertainties during schedule generation. The schedule may then include different contingent events depending upon certain occurrences, such as without limitation user data, update data, and/or evaluation results. In some cases, a conditional planned 400 may generate partial plans or schedule components. In this cases, a conditional planner may determine what chunks or schedule components a schedule may be comprised of without forcing a complete plan or schedule of everything from start to finish. In some cases, this approach may help to reduce state space and solve much more complex problems, perhaps allowing for more domains to be considered during scheduling.

With continued reference to FIG. 4, in some cases conditional planning may include contingent planning. Contingent planning may be used when a user's status within a domain (i.e., domain status) may be observable by way of user data and/or update data. As user data and/or update data may provide only an incomplete or imperfect representation of domain status, planner may act incomplete information. For a contingent planning problem, a schedule may no longer be a sequence of events but a decision tree, as each step of the schedule may be represented by a set of states rather than a single perfectly observable state. Contingent planning may also be used when an effect an event will have on a domain state is not knowable a priori and is thus indeterminable. A selected event therefore may depend on state of domains or user. For example, if event fits schedule for Tuesday afternoon, then event will be Tuesday afternoon, otherwise event may be Thursday morning. A particular case of contiguous planning may be represented by fully-observable and non-deterministic (FOND) problems.

With continued reference to FIG. 4, in some cases, conditional planning may include conformant planning. Conformant planning may be employed when planner is uncertain about state of domain or user and cannot make any observations. For example, between periods of update data. In this cases, planner is unable to verify beliefs about user's status, for instance within at least a domain. In some cases, conformant planning may proceed similar to methods for classical planning. Exemplary non-limiting computer languages for planning include Stanford Research Institute Problem Solver (STRIPS), graphplan, Planning Domain Definition Language (PDDL), and Action Description Language (ADL). An alternative language for describing planning problems may include hierarchical task networks, in which a set of tasks may be given. In some cases, each task can be either realized by a primitive action or event or decomposed into a set of other tasks. In some cases, a hierarchical task network may not involve state variables, although in some cases state variables may be used and may simplify description of task networks.

Referring now to FIG. 5, an exemplary embodiment of neural network 500, for example a feed-forward network, is illustrated. A neural network 500 also known as an artificial neural network, is a network of “nodes,” or data structures having one or more inputs, one or more outputs, and a function determining outputs based on inputs. Such nodes may be organized in a network, such as without limitation a convolutional neural network, including an input layer of nodes 504, one or more intermediate layers 508, and an output layer of nodes 512. Connections between nodes may be created via the process of “training” the network, in which elements from a training dataset are applied to the input nodes, a suitable training algorithm (such as Levenberg-Marquardt, conjugate gradient, simulated annealing, or other algorithms) is then used to adjust the connections and weights between nodes in adjacent layers of the neural network to produce the desired values at the output nodes. This process is sometimes referred to as deep learning. Connections may run solely from input nodes toward output nodes in a “feed-forward” network or may feed outputs of one layer back to inputs of the same or a different layer in a “recurrent network.”

Referring now to FIG. 6, an exemplary embodiment of a node 600 of a neural network is illustrated. A node 600 may include, without limitation a plurality of inputs x; that may receive numerical values from inputs to a neural network containing the node and/or from other nodes. Node 600 may perform a weighted sum of inputs using weights w; that are multiplied by respective inputs xᵢ. Additionally or alternatively, a bias b may be added to the weighted sum of the inputs such that an offset is added to each unit in the neural network layer that is independent of the input to the layer. The weighted sum may then be input into a function φ, which may generate one or more outputs y. Weight wᵢ applied to an input xᵢ may indicate whether the input is “excitatory,” indicating that it has strong influence on the one or more outputs y, for instance by the corresponding weight having a large numerical value, and/or a “inhibitory,” indicating it has a weak effect influence on the one more inputs y, for instance by the corresponding weight having a small numerical value. The values of weights wᵢ may be determined by training a neural network using training data, which may be performed using any suitable process as described above.

Referring again to FIG. 1, In some embodiments, computing device 104 may be configured to modify a training set in response to user data, update data, and/or a scheduling change request. For example, computing device 104 may, in some cases, retrain a machine-learning model, for instance target-setting machine learning model 128, scheduling machine-learning model 140, and/or evaluating machine-learning model 156. In some embodiments, computing device 104 may be configured to classify at least domain target 124a-n and determine a confidence metric. For example, in some exemplary embodiments confidence metric may be a floating-point number within a prescribed range, such as without limitation 0 to 1, with each end of the prescribed range representing an extreme representation, such as without limitation substantially no confidence and substantially absolute confidence, respectively. In some cases, confidence metric may represent a relationship between a result of filtering and/or classifying at least a domain target 124a-n. Confidence metric may be determined by one more comparisons algorithms, such as without limitation a fuzzy set comparison. For example, in some exemplary embodiments a fuzzy set comparison may be employed to compare domain specific data 120a-n with a membership function derived to represent at least a domain target 124a-n for classification.

Referring to FIG. 7, an exemplary embodiment of fuzzy set comparison 700 is illustrated. A first fuzzy set 704 may be represented, without limitation, according to a first membership function 708 representing a probability that an input falling on a first range of values 712 is a member of the first fuzzy set 704, where the first membership function 708 has values on a range of probabilities such as without limitation the interval [0,1], and an area beneath the first membership function 708 may represent a set of values within first fuzzy set 704. Although first range of values 712 is illustrated for clarity in this exemplary depiction as a range on a single number line or axis, first range of values 712 may be defined on two or more dimensions, representing, for instance, a Cartesian product between a plurality of ranges, curves, axes, spaces, dimensions, or the like. First membership function 708 may include any suitable function mapping first range 712 to a probability interval, including without limitation a triangular function defined by two linear elements such as line segments or planes that intersect at or below the top of the probability interval. As a non-limiting example, triangular membership function may be defined as:

$$y ( x , a , b , c ) = \{ \begin{matrix}0 , & for x > c and x < a \\ \frac{x - a}{b - a} , & for a \leq x < b \\ \frac{c - x}{c - b} , & if b < x \leq c\end{matrix}$$

a trapezoidal membership function may be defined as:

$$y ( x , a , b , c , d ) = max ( min ( \frac{x - a}{b - a} , 1 , \frac{d - x}{d - c} ) , 0 )$$

a sigmoidal function may be defined as:

$$y ( x , a , c ) = \frac{1}{1 - {e}^{- a ( x - c )}}$$

a Gaussian membership function may be defined as:

$$y ( x , c , σ ) = {e}^{- \frac{1}{2} {( \frac{x - c}{σ} )}^{2}}$$

and a bell membership function may be defined as:

$$y ( x , a , b , c , ) = {[ 1 + {\vert \frac{x - c}{a} \vert}^{2 b} ]}^{- 1}$$

Persons skilled in the art, upon reviewing the entirety of this disclosure, will be aware of various alternative or additional membership functions that may be used consistently with this disclosure.

Still referring to FIG. 7, first fuzzy set 704 may represent any value or combination of values as described above, including output from one or more machine-learning models and user data from remote device 108, a predetermined class, such as without limitation a domain status and/or a domain target. A second fuzzy set 716, which may represent any value which may be represented by first fuzzy set 704, may be defined by a second membership function 720 on a second range 724; second range 724 may be identical and/or overlap with first range 712 and/or may be combined with first range via Cartesian product or the like to generate a mapping permitting evaluation overlap of first fuzzy set 704 and second fuzzy set 716. Where first fuzzy set 704 and second fuzzy set 716 have a region 728 that overlaps, first membership function 708 and second membership function 720 may intersect at a point 732 representing a probability, as defined on probability interval, of a match between first fuzzy set 704 and second fuzzy set 716. Alternatively or additionally, a single value of first and/or second fuzzy set may be located at a locus 736 on first range 712 and/or second range 724, where a probability of membership may be taken by evaluation of first membership function 708 and/or second membership function 720 at that range point. A probability at 728 and/or 732 may be compared to a threshold 740 to determine whether a positive match is indicated. Threshold 740 may, in a non-limiting example, represent a degree of match between first fuzzy set 704 and second fuzzy set 716, and/or single values therein with each other or with either set, which is sufficient for purposes of the matching process; for instance, threshold may indicate a sufficient degree of overlap between an output from one or more machine-learning models and/or user data from remote device 108 and a predetermined class, such as without limitation a domain status and/or domain target, for combination to occur as described above. Alternatively or additionally, each threshold may be tuned by a machine-learning and/or statistical process, for instance and without limitation as described in further detail below.

Further referring to FIG. 7, in an embodiment, a degree of match between fuzzy sets may be used to classify. For instance, if a domain-specific data has a fuzzy set matching a domain target fuzzy set by having a degree of overlap exceeding a threshold, computing device 104 may classify the domain-specific data as belonging to the domain target. Where multiple fuzzy matches are performed, degrees of match for each respective fuzzy set may be computed and aggregated through, for instance, addition, averaging, or the like, to determine an overall degree of match.

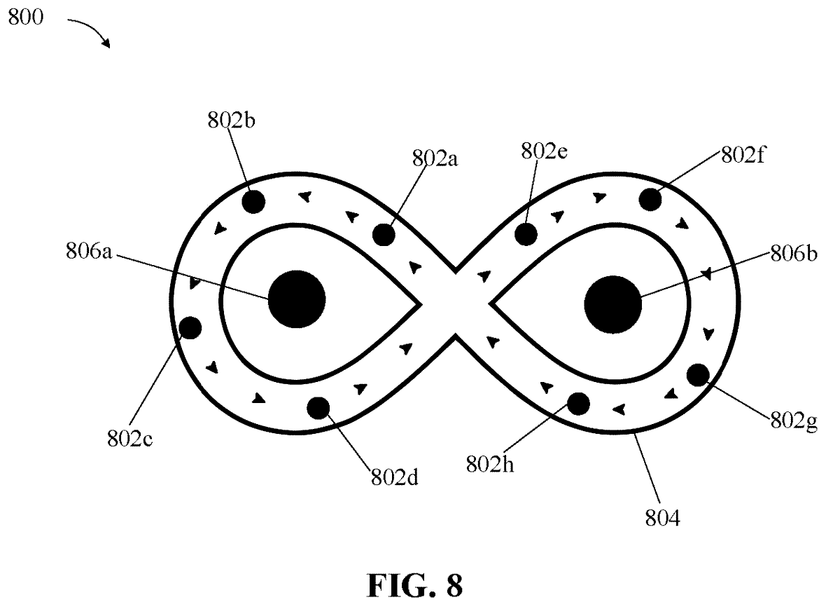

Now referring to FIG. 8, an exemplary system architecture is illustrated comprising an infinity loop representation 800 configured to model the progression, regression, and adaptive transitions across a structured set of motivational courage types. In the illustrated embodiment, infinity loop representation 800 includes eight courage-phase nodes 802a-802h, each corresponding to a distinct courage type in a defined transformational order: Engage Faith 802a, Gain Clarity 802b, Make Commitment 802c, Be Creative 802d, Develop Capability 802c, Achieve Consistency 802f, Authentically Rest 802g, and Proactively Repeat 802h. These nodes are interconnected by directional edges 804 indicating forward phase flow, as well as optional bidirectional or loop-back paths that support dynamic transitions, recursive advancement, or reentry following rest phases. In some embodiments, eliminator nodes 806a and 806b may be logically positioned at inflection points within the loop structure and configured to detect, mitigate, or resolve stagnation, vice, or motivational depletion.

With further reference to FIG. 8, in some embodiments, eliminator nodes may include at least a vice eliminator 806a and a stagnation/depletion eliminator 806b, each operatively connected to specific courage-phase nodes based on empirical patterns of user regression or motivational drop-off. Vice eliminator 806a may be positioned upstream of the Make Commitment phase 802c and configured to detect habitual avoidance behaviors, maladaptive patterns, or conflicting value systems that prevent a user from progressing beyond initial ideation. The vice eliminator 806a may trigger a targeted intervention sequence including reflective journaling prompts, guided dialogue modules, or curated content designed to help the user identify and neutralize such self-defeating patterns before recommitting to a phase transition. Stagnation/depletion eliminator 806b may be linked to phases such as Achieve Consistency 802f or Authentically Rest 802g and configured to identify prolonged inaction, disengagement, or cognitive burnout. In these cases, the eliminator module may invoke recalibration prompts, energy-restoration protocols, or system-initiated phase regression suggestions designed to reestablish user momentum or reroute effort to a prior growth-enabling courage phase (e.g., Be Creative 802d). Each eliminator node may access user-specific telemetry and contextual indicators, including temporal drift from expected phase durations, declining sentiment scores, task non-compliance, or adverse physiological patterns, to determine the need for intervention. Outputs from eliminator nodes 806 may also feed back into the courage typing layer or courage classification model for real-time reclassification, thereby reinforcing the system's capacity to detect and recover from motivational derailment within the dynamic flow of the infinity loop representation 800.

In continued reference to FIG. 8, infinity loop representation 800 may be computationally encoded within system 100 as described in FIG. 1, and leveraged by the courage typing layer, scheduling machine learning model, and evaluating machine learning model to determine phase alignment, generate task recommendations, schedule adaptive check-ins, and select appropriate content or interventions. In some embodiments, phase transitions may be governed by phase-specific rulesets, threshold conditions, or user-response classifiers trained on historical data associated with successful progression patterns. System 100 may maintain a current-phase state vector associated with each user, which is dynamically updated based on system inputs, including journaling content, prompt responses, engagement history, physiological or behavioral telemetry, and explicit user feedback. The infinity loop structure thereby may act as a system-level backbone for motivational logic, unifying temporal progression, task orchestration, and adaptive feedback across personalized user journeys.

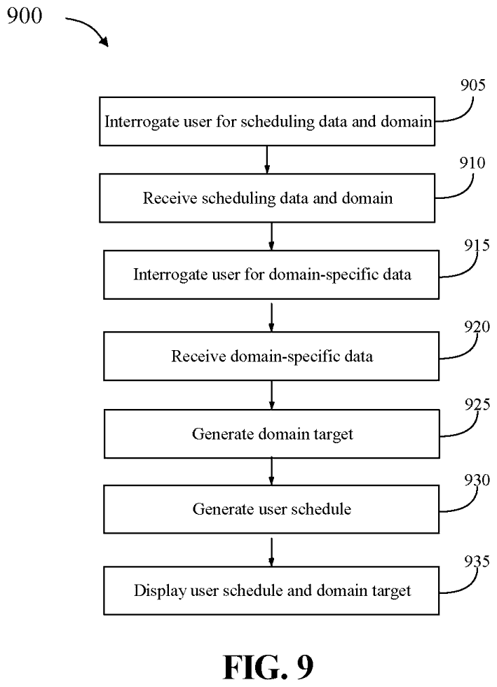

Referring now to FIG. 9, a method 900 of exploiting value within certain domains is illustrated by way of a flow diagram. At step 905, method 900 may include interrogating a user for scheduling data and at least a domain. User may include any user described in this disclosure, for example including with reference to FIGS. 1-8. Scheduling data may include any scheduling described in this disclosure, for example including with reference to FIGS. 1-8. Domain may include any domain described in this disclosure, for example including with reference to FIGS. 1-8. In some cases, at least a domain may include at least one domain and no more than a predetermined maximum number of domains.

With continued reference to FIG. 9, at step 910, method 900 may include receiving scheduling data and at least a domain from the user.

With continued reference to FIG. 9, at step 915, method 900 may include interrogating user for domain-specific data associated with at least a domain. Domain-specific data may include any domain-specific data described in this disclosure, for example including with reference to FIGS. 1-8. In some embodiments, at least a domain target may include a quarterly target.

With continued reference to FIG. 9, at step 920, method 900 may include receiving domain-specific data from user.

With continued reference to FIG. 9, at step 925, method 900 may include generating at least a domain target for at least a domain as a function of domain-specific data. Domain target may include any domain target described in this disclosure, for example including with reference to FIGS. 1-8. In some embodiments, step 925 may additionally include inputting domain-specific data to a target-setting machine learning model and generating at least a domain target as a function of the domain-specific data and the target-setting machine learning model. Target-setting machine learning model may include any machine-learning process described in this disclosure, including with reference to FIGS. 1-8. In some embodiments, method 900 may additionally include training target-setting machine learning model. In some cases, training target-setting machine learning model includes inputting target-setting training data to a machine learning algorithm and training the target-setting machine learning model as a function of the machine-learning algorithm. Target-setting training data may include any training data described in this disclosure, for example with reference to FIGS. 1-8. In some cases, target-setting training data includes a plurality of domain-specific data correlated to a domain target.

With continued reference to FIG. 9, at step 930, method 900 may include generating at least a user schedule as a function of at least a domain target and scheduling data. User schedule may include any user schedule described in this disclosure, for example including with reference to FIGS. 1-8. In some embodiments, step 930 may additionally include inputting at least a domain target and scheduling data to a scheduling machine learning model and generating at least a user schedule as a function of the scheduling machine learning model. Scheduling machine learning model may include any machine learning model described in this disclosure, including with reference to FIGS. 1-8. In some embodiments, method 900 may additionally include training scheduling machine learning model. In some cases, training scheduling machine learning model may include inputting scheduling training data to a machine learning algorithm and training the scheduling machine learning model as a function of the machine-learning algorithm. Scheduling training data may include any training data described in this disclosure, including with reference to FIGS. 1-8. In some cases, wherein scheduling training data may include a plurality of domain targets correlated to schedule components. In some embodiments, at least a user schedule includes a weekly schedule.

With continued reference to FIG. 9, at step 935, method 900 may include displaying at least a user schedule and at least a domain target to the user.

Still referring to FIG. 9, in some embodiments, method 900 may additionally include interrogating user for update data, evaluating the update data as a function of at least a user schedule, and displaying evaluation results to the user. In some cases, update data may include objective update data. In some cases, update data may include subjective update data. In some embodiments, evaluating update data may include inputting the update data and at least a user schedule to an evaluating machine learning model, and generating evaluation results as a function of the evaluating machine learning model. Evaluating machine learning model may include any machine learning process described in this disclosure, including with reference to FIGS. 1-8. In some embodiments, method 900 may additionally include training evaluating machine learning model. In some cases, training evaluating machine learning model may include inputting evaluating training data to a machine learning algorithm and training the evaluating machine learning model as a function of the machine-learning algorithm. Evaluating training data may include any training data described in this disclosure, including with reference to FIGS. 1-8. In some cases, evaluating training data may include a plurality of update data correlated to evaluations. In some embodiments, method 900 may additionally include notifying user as a function of evaluation results. In some cases, notifying user may include a text message. In some cases, notifying a user may include an authorized notification.

Still referring to FIG. 9, in some embodiments, method 900 may additionally include receiving at least a schedule change request from user and modifying at least a user schedule as a function of the schedule change request.

It is to be noted that any one or more of the aspects and embodiments described herein may be conveniently implemented using one or more machines (e.g., one or more computing devices that are utilized as a user computing device for an electronic document, one or more server devices, such as a document server, etc.) programmed according to the teachings of the present specification, as will be apparent to those of ordinary skill in the computer art. Appropriate software coding can readily be prepared by skilled programmers based on the teachings of the present disclosure, as will be apparent to those of ordinary skill in the software art. Aspects and implementations discussed above employing software and/or software modules may also include appropriate hardware for assisting in the implementation of the machine executable instructions of the software and/or software module.

Such software may be a computer program product that employs a machine-readable storage medium. A machine-readable storage medium may be any medium that is capable of storing and/or encoding a sequence of instructions for execution by a machine (e.g., a computing device) and that causes the machine to perform any one of the methodologies and/or embodiments described herein. Examples of a machine-readable storage medium include, but are not limited to, a magnetic disk, an optical disc (e.g., CD, CD-R, DVD, DVD-R, etc.), a magneto-optical disk, a read-only memory “ROM” device, a random access memory “RAM” device, a magnetic card, an optical card, a solid-state memory device, an EPROM, an EEPROM, and any combinations thereof. A machine-readable medium, as used herein, is intended to include a single medium as well as a collection of physically separate media, such as, for example, a collection of compact discs or one or more hard disk drives in combination with a computer memory. As used herein, a machine-readable storage medium does not include transitory forms of signal transmission.

Such software may also include information (e.g., data) carried as a data signal on a data carrier, such as a carrier wave. For example, machine-executable information may be included as a data-carrying signal embodied in a data carrier in which the signal encodes a sequence of instruction, or portion thereof, for execution by a machine (e.g., a computing device) and any related information (e.g., data structures and data) that causes the machine to perform any one of the methodologies and/or embodiments described herein.

Examples of a computing device include, but are not limited to, an electronic book reading device, a computer workstation, a terminal computer, a server computer, a handheld device (e.g., a tablet computer, a smartphone, etc.), a web appliance, a network router, a network switch, a network bridge, any machine capable of executing a sequence of instructions that specify an action to be taken by that machine, and any combinations thereof. In one example, a computing device may include and/or be included in a kiosk.

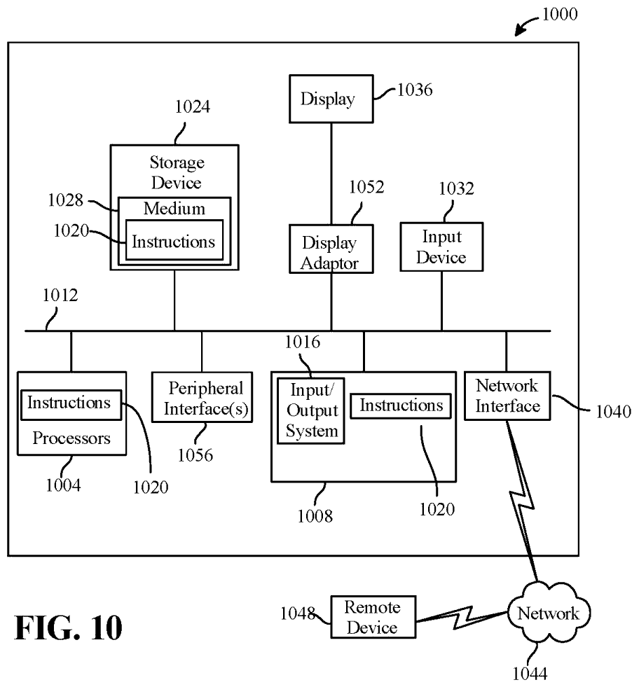

FIG. 10 shows a diagrammatic representation of one embodiment of a computing device in the exemplary form of a computer system 1000 within which a set of instructions for causing a control system to perform any one or more of the aspects and/or methodologies of the present disclosure may be executed. It is also contemplated that multiple computing devices may be utilized to implement a specially configured set of instructions for causing one or more of the devices to perform any one or more of the aspects and/or methodologies of the present disclosure. Computer system 1000 includes a processor 1004 and a memory 1008 that communicate with each other, and with other components, via a bus 1012. Bus 1012 may include any of several types of bus structures including, but not limited to, a memory bus, a memory controller, a peripheral bus, a local bus, and any combinations thereof, using any of a variety of bus architectures.

Processor 1004 may include any suitable processor, such as without limitation a processor incorporating logical circuitry for performing arithmetic and logical operations, such as an arithmetic and logic unit (ALU), which may be regulated with a state machine and directed by operational inputs from memory and/or sensors; processor 1004 may be organized according to Von Neumann and/or Harvard architecture as a non-limiting example. Processor 1004 may include, incorporate, and/or be incorporated in, without limitation, a microcontroller, microprocessor, digital signal processor (DSP), Field Programmable Gate Array (FPGA), Complex Programmable Logic Device (CPLD), Graphical Processing Unit (GPU), general purpose GPU, Tensor Processing Unit (TPU), analog or mixed signal processor, Trusted Platform Module (TPM), a floating-point unit (FPU), and/or system on a chip (SoC).

Memory 1008 may include various components (e.g., machine-readable media) including, but not limited to, a random-access memory component, a read only component, and any combinations thereof. In one example, a basic input/output system 1016 (BIOS), including basic routines that help to transfer information between elements within computer system 1000, such as during start-up, may be stored in memory 1008. Memory 1008 may also include (e.g., stored on one or more machine-readable media) instructions (e.g., software) 1020 embodying any one or more of the aspects and/or methodologies of the present disclosure. In another example, memory 1008 may further include any number of program modules including, but not limited to, an operating system, one or more application programs, other program modules, program data, and any combinations thereof.

Computer system 1000 may also include a storage device 1024. Examples of a storage device (e.g., storage device 1024) include, but are not limited to, a hard disk drive, a magnetic disk drive, an optical disc drive in combination with an optical medium, a solid-state memory device, and any combinations thereof. Storage device 1024 may be connected to bus 1012 by an appropriate interface (not shown). Example interfaces include, but are not limited to, SCSI, advanced technology attachment (ATA), serial ATA, universal serial bus (USB), IEEE 1394 (FIREWIRE), and any combinations thereof. In one example, storage device 1024 (or one or more components thereof) may be removably interfaced with computer system 1000 (e.g., via an external port connector (not shown)). Particularly, storage device 1024 and an associated machine-readable medium 1028 may provide nonvolatile and/or volatile storage of machine-readable instructions, data structures, program modules, and/or other data for computer system 1000. In one example, software 1020 may reside, completely or partially, within machine-readable medium 1028. In another example, software 1020 may reside, completely or partially, within processor 1004.

Computer system 1000 may also include an input device 1032. In one example, a user of computer system 1000 may enter commands and/or other information into computer system 1000 via input device 1032. Examples of an input device 1032 include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), a touchscreen, and any combinations thereof. Input device 1032 may be interfaced to bus 1012 via any of a variety of interfaces (not shown) including, but not limited to, a serial interface, a parallel interface, a game port, a USB interface, a FIREWIRE interface, a direct interface to bus 1012, and any combinations thereof. Input device 1032 may include a touch screen interface that may be a part of or separate from display 1036, discussed further below. Input device 1032 may be utilized as a user selection device for selecting one or more graphical representations in a graphical interface as described above.

A user may also input commands and/or other information to computer system 1000 via storage device 1024 (e.g., a removable disk drive, a flash drive, etc.) and/or network interface device 1040. A network interface device, such as network interface device 1040, may be utilized for connecting computer system 1000 to one or more of a variety of networks, such as network 1044, and one or more remote devices 1048 connected thereto. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network, such as network 1044, may employ a wired and/or a wireless mode of communication. In general, any network topology may be used. Information (e.g., data, software 1020, etc.) may be communicated to and/or from computer system 1000 via network interface device 1040.

Computer system 1000 may further include a video display adapter 1052 for communicating a displayable image to a display device, such as display device 1036. Examples of a display device include, but are not limited to, a liquid crystal display (LCD), a cathode ray tube (CRT), a plasma display, a light emitting diode (LED) display, and any combinations thereof. Display adapter 1052 and display device 1036 may be utilized in combination with processor 1004 to provide graphical representations of aspects of the present disclosure. In addition to a display device, computer system 1000 may include one or more other peripheral output devices including, but not limited to, an audio speaker, a printer, and any combinations thereof. Such peripheral output devices may be connected to bus 1012 via a peripheral interface 1056. Examples of a peripheral interface include, but are not limited to, a serial port, a USB connection, a FIREWIRE connection, a parallel connection, and any combinations thereof.

The foregoing has been a detailed description of illustrative embodiments of the invention. Various modifications and additions can be made without departing from the spirit and scope of this invention. Features of each of the various embodiments described above may be combined with features of other described embodiments as appropriate in order to provide a multiplicity of feature combinations in associated new embodiments. Furthermore, while the foregoing describes a number of separate embodiments, what has been described herein is merely illustrative of the application of the principles of the present invention. Additionally, although particular methods herein may be illustrated and/or described as being performed in a specific order, the ordering is highly variable within ordinary skill to achieve methods, systems, and software according to the present disclosure. Accordingly, this description is meant to be taken only by way of example, and not to otherwise limit the scope of this invention.

Exemplary embodiments have been disclosed above and illustrated in the accompanying drawings. It will be understood by those skilled in the art that various changes, omissions and additions may be made to that which is specifically disclosed herein without departing from the spirit and scope of the present invention.

What is claimed is:

1. A method of exploiting value within a certain domain, the method comprising:
receiving, by a computing device:
scheduling data;
at least a domain, wherein a quantity of domains in the at least a domain is between one and a predetermined maximum number of domains selected by a user; and
domain-specific data, wherein the domain-specific data is a function of the at least a domain;
generating, using a target-setting machine learning model that has been trained on target-setting training data comprising an exemplary plurality of domain-specific data correlated to an exemplary domain target, at least a domain target for the at least a domain as a function of the domain-specific data;
generating, using a scheduling machine learning model that has been trained on scheduling training data comprising exemplary domain targets with exemplary user schedules, the at least a user schedule, wherein generating the at least a user schedule comprises:
receiving a status of at least a domain;
assigning one or more state variables to the at least a domain, wherein the one or more state variables represent the status of the at least a domain; and
generating the at least a user schedule as a function of the one or more state variables; and
displaying, by the computing device, the at least a user schedule and the at least a domain target to the user.

2. The method of claim 1, further comprising identifying an effective motivation path for the user using a machine learning model that has been trained on training data comprising previous outputs correlated with subsequent updates for users generally, wherein the machine learning model is further updated as a function of user-specific data to refine the effective motivation path for the user.

3. The method of claim 1, further comprising identifying an effective motivation path for the user, wherein identifying an effective motivation path for the user comprises:
classifying the user into a cohort of similar users;
selecting a machine learning model that has been trained on training data comprising previous outputs correlated to updates for the cohort of similar users; and
identifying the effective motivation path as a function of the selected machine learning model.

4. The method of claim 1, further comprising determining an inferred courage type for the user using a courage typing layer, wherein the courage typing layer is configured to identify a form of motivational courage from a set of predefined courage types arranged in a progressive order.

5. The method of claim 4, wherein determining the inferred courage type comprises:
receiving, by the computing device, user input comprising at least textual input;
processing the user input using a natural language processing engine to extract at least a semantic indicator of motivational state; and
classifying the user, using the courage typing layer and as a function of the at least a semantic indicator of motivational state, into at least one of the set of predefined courage types.

6. The method of claim 4, further comprising modifying, by the computing device, one or more of the at least a user schedule and a motivational feedback message as a function of the inferred courage type.

7. The method of claim 4, further comprising surfacing, through a graphical user interface, one or more of courage-aligned coaching prompts, media content, and milestone suggestions selected from a content delivery engine as a function of the inferred courage type.

8. The method of claim 4, further comprising:
receiving, by the computing device, user data comprising at least textual input and schedule adherence data;
identifying, using a natural language processing engine and the courage typing layer comprising a classifier trained to detect transitional motivational states; and
triggering an eliminator intervention as a function of the transitional motivational state.

9. The method of claim 4, further comprising generating at least an adaptive check-in point as a function of a system time constraint and the inferred courage type.

10. The method of claim 4, further comprising:
monitoring, using the computing device, a sequence of inferred courage types over time for the user;
detecting, using the computing device, at least one courage-type transitions within the sequence; and
triggering, as a function of detecting the at least one courage-type transitions, a retraining of the courage typing layer using historical transition data of the user as training data.

11. A system for exploiting value within a certain domain, the system comprising a computing device configured to:
receive at the computing device:
scheduling data;
at least a domain, wherein a quantity of domains in the at least a domain is between one and a predetermined maximum number of domains selected by a user; and
domain-specific data, wherein the domain-specific data is a function of the at least a domain;
generate, using a target-setting machine learning model that has been trained on target-setting training data comprising an exemplary plurality of domain-specific data correlated to an exemplary domain target, at least a domain target for the at least a domain as a function of the domain-specific data;
generate, using a scheduling machine learning model that has been trained on scheduling training data comprising exemplary domain targets with exemplary user schedules, the at least a user schedule, wherein generating the at least a user schedule comprises:
receiving a status of at least a domain;
assigning one or more state variables to the at least a domain, wherein the one or more state variables represent the status of the at least a domain; and
generating the at least a user schedule as a function of the one or more state variables; and
display, at the computing device, the at least a user schedule and the at least a domain target to the user.

12. The system of claim 11, wherein the computing device is further configured to identify an effective motivation path for the user using a machine learning model that has been trained on training data comprising previous outputs correlated with subsequent updates for users generally, wherein the machine learning model is further updated as a function of user-specific data to refine the effective motivation path for the user.

13. The system of claim 11, wherein the computing device is further configured to identify an effective motivation path for the user, wherein identifying an effective motivation path for the user comprises:
classifying the user into a cohort of similar users;
selecting a machine learning model that has been trained on training data comprising previous outputs correlated to updates for the cohort of similar users; and
identifying the effective motivation path as a function of the selected machine learning model.

14. The system of claim 11, wherein the computing device is further configured to determine an inferred courage type for the user using a courage typing layer, wherein the courage typing layer is configured to identify a form of motivational courage from a set of predefined courage types arranged in a progressive order.

15. The system of claim 14, wherein determining the inferred courage type comprises:
receiving, by the computing device, user input comprising at least textual input;
processing the user input using a natural language processing engine to extract at least a semantic indicator of motivational state; and
classifying the user, using the courage typing layer and as a function of the at least a semantic indicator of motivational state, into at least one of the set of predefined courage types.

16. The system of claim 14, wherein the computing device is further configured to modify one or more of the at least a user schedule and a motivational feedback message as a function of the inferred courage type.

17. The system of claim 14, wherein the computing device is further configured to surface, to a graphical user interface, one or more of courage-aligned coaching prompts, media content, and milestone suggestions selected from a content delivery engine as a function of the inferred courage type.

18. The system of claim 14, wherein the computing device is further configured to:
receive user data comprising at least textual input and schedule adherence data;
identify, using a natural language processing engine and the courage typing layer comprising a classifier trained to detect transitional motivational states; and
trigger an eliminator intervention as a function of the transitional motivational state.

19. The system of claim 14, wherein the computing device is further configured to generate at least an adaptive check-in point as a function of a system time constraint and the inferred courage type.

20. The system of claim 14, wherein the computing device is further configured to:
monitor a sequence of inferred courage types over time for the user;
detect at least one courage-type transitions within the sequence; and
trigger, as a function of detecting the at least one courage-type transitions, a retraining of the courage typing layer using historical transition data of the user as training data.
